(19) United States
(12) Patent Application Publication
(10) Pub. No.: US 2023/0357028 A1
(43) Pub. Date: Nov. 9, 2023

(54) METHOD FOR PRODUCING HYDROGENATED POLYSILANE COMPOUND

(71) Applicant: NIPPON SHOKUBAI CO., LTD., Osaka (JP)

(72) Inventors: Akira NISHIMURA, Osaka (JP); Tetsuya YAMAMOTO, Osaka (JP); Takashi ABE, Osaka (JP)

(73) Assignee: NIPPON SHOKUBAI CO., LTD., Osaka (JP)

(21) Appl. No.: 18/024,818

(22) PCT Filed: Sep. 7, 2021
(86) PCT No.: PCT/JP2021/032918

§ 371 Date: Mar. 6, 2023

(30) Foreign Application Priority Data
Sep. 8, 2020 (JP) 2020-150656
Sep. 8, 2020 (JP) 2020-150657
Mar. 31, 2021 (JP) 2021-059690

(51) Int. Cl. C01B 33/107

(52) U.S. Cl. CPC C01B 33/10778

(57) ABSTRACT

The purpose of the present invention is to produce a high quality hydrogenated polysilane compound by reducing process troubles using the halosilane raw material and the reducing agent.

A method for producing a hydrogenated polysilane compound (CX) of the present invention contains a reducing step (P1) in which a halosilane raw material (C0) selected from a polyhalosilane compound (C1) comprising a Si—Si bond and a Si—X bond (X represents a halogen atom) in the same molecule, a salt of the polyhalosilane compound (C2), and a complex of the polyhalosilane compound (C3) is contacted with a reducing agent (R2) to reduce the halosilane raw material (C0), and a removing step in which a reaction solution of the reducing step (P1) is subjected to one or more steps selected from the following (T1) to (T4) to remove the reducing agent (R2) and/or a resulting material of the reducing agent (R2) contained in the reaction solution.
(T1) separating step of a solid and a liquid
(T2) separating step of one liquid and another comprising a reaction solution, a concentrated solution of the reaction solution, or a washing solution of the reaction solution or the concentrated solution of the reaction solution
(T3) contacting step with an acid aqueous solution
(T4) distilling step of the hydrogenated polysilane compound (CX)

### TECHNICAL FIELD

The present invention relates to a method for producing a hydrogenated polysilane compound using a reducing agent. More particularly, the present invention relates to a method for producing a cyclic hydrogenated silane compound.

### BACKGROUND ART

Thin silicon film is used in solar cells, semiconductors, etc. Conventionally, the thin silicon film is produced by chemical vapor deposition (CVD) method using monosilane or other materials. Other methods for manufacturing silicon films include a CVD method using a hydrogenated polysilane compound (a cyclic hydrogenated silane) as the raw material, and a method for producing a thin silicon film by coating on a substrate a solution of a hydrogenated polysilane compound (a cyclic hydrogenated silane) or a solution containing a polymer of the hydrogenated polysilane compound prepared by photopolymerization as the solute and baking a coating.

As an example of a method for producing the cyclic hydrogenated silane, Non-Patent Document 1 describes a method for producing cyclohexasilane in which LiAlH₄ in a diethyl ether solution is added to a salt of a cyclic halosilane compound of [(Et₂NCH₂CH₂)₂NEt·H₂SiCl]₂[Si₆Cl₁₄] in a diethyl ether solution to reduce the salt of the cyclic halosilane compound, the solid product is removed by filtration and washed with diethyl ether, a filtrate is concentrated under vacuum, a crude product is extracted with pentane, an extract containing pentane is washed by adding 9N sulfuric acid, an organic layer is dried over Na₂SO₄, filtered, and distilled under reduced pressure to produce cyclohexasilane.

As other method for producing the cyclic hydrogenated silane compound, there is a known method in which a salt of a cyclic halosilane compound is contacted with an aluminum halide compound (e.g., a Lewis acid compound) to obtain a cyclic halosilane compound, and then the resulting cyclic halosilane compound is contacted with a metal hydride to reduce the cyclic halosilane compound (Patent Document 1).

Furthermore, there is a known method for producing a hydrogenated polysilane compound (a cyclic hydrogenated silane) in which a perphenylcyclosilane mixture is mixed with a Lewis acid compound to prepare a dispersion, hydrogen chloride gas is introduced by bubbling into the resulting dispersion, and then a cyclic halosilane compound is reacted with a reducing agent of lithium aluminum hydride, and the like (Patent Document 2).

In addition, Patent document 2 discloses that a cyclic hydrogenated silane compound is obtained by reducing a cyclic halosilane compound with a metal hydride and then purifying a resulting material by concentration or distillation, and that the cyclic hydrogenated silane compound is produced with an aluminum complex and contains a large amount of aluminum compounds, and the amount of aluminum compounds is reduced by washing with water because a large amount of aluminum affects the electrical properties of the thin film.

### PRIOR ART DOCUMENT

### Patent Document

Patent Document 1: Japanese Unexamined Patent Application Publication No. 2017-95324
Patent Document 2: U.S. Pat. No. 7,498,015

### Non-Patent Document

Non-Patent Document 1: Xiaotang Lu et al., “Low Temperature Colloidal Synthesis of Silicon Nanorods from Isotetrasilane, Neopentasilane, and Cyclohexasilane”, Chem. Mater., 27, p 6053 (2015)

### SUMMARY OF THE INVENTION

### Problems to be Solved by the Invention

From the above, a hydrogenated polysilane compound (preferably a cyclic hydrogenated silane compound) is prepared using a halosilane raw material and a reducing agent. It is desired that the hydrogenated polysilane compound (preferably the cyclic hydrogenated polysilane compound) is separated from a component derived from a reducing agent (preferably an aluminum-containing component derived from a reducing agent), an aluminum-containing component used in the synthesis of a halosilane raw material that is not derived from a reducing agent (e.g., an aluminum-containing component derived from a Lewis acid compound) and a resulting material of a reducing agent. There is a problem that the component derived from the separated reducing agent (preferably the aluminum-containing component derived from the reducing agent), the aluminum-containing component used in the synthesis of the halosilane raw material that is not derived from the reducing agent (e.g., the aluminum-containing component derived from the Lewis acid compound) and the resulting material of the reducing agent form residue or adhere to pipes, resulting in process troubles.

Therefore, the purpose of the present invention is to produce a high quality hydrogenated polysilane compound by reducing process troubles using the halosilane raw material and the reducing agent.

A more detailed examples of the above process troubles are as follows. The present inventors have found that, as in the method known in Non-Patent Document 1 in which solids are filtered from a reaction solution after the reduction of a salt of a cyclic halosilane compound, when the reaction solution containing the solids is transported, the component derived from the reducing agent (for example, the aluminum-containing component derived from the reducing agent), the aluminum-containing component used in the synthesis of the halosilane raw material that is not derived from the reducing agent (for example, the aluminum-containing component derived from the Lewis acid compound) and the resulting material of the reducing agent stick to the transport route. The present inventors also have found that the accumulation of the stuck substances may cause blockage or ignition of the transport route. Furthermore, the present inventors have found that there is a problem that the solids are stuck in the filter and the transport route in the case where the solids with a risk of ignition after filtration are processed such that the solids are removed from the filter and the solids are collected after dispersing with a solvent.

Thus, in an aspect, an object of the present invention is to provide a method for efficiently producing a cyclic hydrogenated silane by reducing the cyclic halosilane compound in which the component derived from the reducing agent (for example, the aluminum-containing component derived from the reducing agent), the aluminum-containing component used in the synthesis of the halosilane raw material that is not derived from the reducing agent (for example, the aluminum-containing component derived from the Lewis acid compound), and the resulting material of the reducing agent are prevented from sticking to production facilities.

On the other hand, in Patent Document 2, a mixture consisting of the perphenylcyclosilane and the aluminum halide compound is contacted with chlorine gas, followed by reaction with a reducing agent. The aluminum complexes precipitate in the reactor as residue, preventing the reduction reaction or other stirring from proceeding smoothly or stopping, and the aluminum complexes react with moisture in the air to generate hydrogen chloride gas in some cases.

In addition, in Patent Document 1, there is room for improving the productivity of the cyclic hydrogenated silane compound by efficiently separating an aluminum complex derived from an aluminum halide compound and a reducing agent.

In an aspect, an object of the present invention is to provide a method for producing a cyclic hydrogenated silane compound in which the aluminum complex formed by the reaction of the salt of the cyclic halosilane compound with the aluminum halide compound or the reaction of the cyclic halosilane compound with the reducing agent is handled with safe and convenience, and the cyclic hydrogenated silane compound are produced with reduced aluminum content at high purity.

Furthermore, in Patent Document 2, lithium salts, aluminum salts, and/or their complexes derived from the Lewis acid compound and/or the lithium aluminum hydride are formed as solid residues, and as a result, the solid residues may adhere to tank walls, piping and the like in the reaction system, so that the cleaning of the solid residues is complicated. In addition, there is a problem that the solid residues are not easy to handle and dispose after the target product is collected. Further, there is a possibility that the solid residues block the piping or filter, or stop the agitation due to adhesion to the agitator.

Furthermore, when the hydrogenated polysilane compound is produced by reduction reaction, the treatment of solid residues is complicated, and the hydrogenated polysilane compound needs to be supplied more safely and stably. In an aspect, an object of the present invention is to provide a method for producing a hydrogenated polysilane compound in which the hydrogenated polysilane compound can be stably and efficiently produced with almost no solid residue when subjected to a reduction reaction.

### Solutions to the Problems

The gist of the present invention to solve the above problem is as follows.
[1] A method for producing a hydrogenated polysilane compound (CX) comprising
   a reducing step (P1) in which a halosilane raw material (C0) selected from a polyhalosilane compound (C1) comprising a Si—Si bond and a Si—X bond (X represents a halogen atom) in the same molecule, a salt of the polyhalosilane compound (C2), and a complex of the polyhalosilane compound (C3) is contacted with a reducing agent (R2) to reduce the halosilane raw material (C0), and
   a removing step in which a reaction solution of the reducing step (P1) is subjected to one or more steps selected from the following (T1) to (T4) to remove the reducing agent (R2) and/or a resulting material of the reducing agent (R2) contained in the reaction solution.
(T1) separating step of a solid and a liquid
(T2) separating step of one liquid and another comprising a reaction solution, a concentrated solution of the reaction solution, or a washing solution of the reaction solution or the concentrated solution of the reaction solution
(T3) contacting step with an acid aqueous solution
(T4) distilling step of the hydrogenated polysilane compound (CX)
[2] The method according to the above [1], wherein the reducing step (P1) is carried out in a batch reactor.
[3] The method according to the above [1], wherein the reducing step (P1) is carried out in a continuous reactor.
[4] The method according to any one of the above [1] to [3], wherein the reducing agent (R2) is a metal hydride (E).
[5] The method according to any one of the above [1] to [4], wherein the reducing agent (R2) is at least one selected from an aluminum hydride compound, a boron hydride compound, a silane hydride compound, a tin hydride compound, and a transition metal hydride compound.
[6] The method according to any one of the above [1] to [5], wherein the reducing agent (R2) and/or the resulting material of the reducing agent (R2) is a liquid at a temperature of 30° C.
[7] The method according to the above [6], wherein the reducing agent (R2) is one of the aluminum hydride compound and the boron hydride compound.
[8] The method according to the above [6] or [7], wherein the reducing agent (R2) is the aluminum hydride compound having Al—R¹ (R¹ is an alkyl group that may be branched) or Al—OR² (R² is an alkyl group that may be branched).
[9] The method according to any one of the above [1] to [8], wherein the contact in the reducing step (P1) is carried out in the presence of a solvent (S1).
[10] The method according to the above [9], wherein the solvent (S1) comprises at least one selected from a hydrocarbon solvent and an ether solvent.
[11] The method according to the above [9], wherein the solvent (S1) comprises the ether solvent.
[12] The method according to the above [9], wherein the solvent (S1) comprises the hydrocarbon solvent.
[13] The method according to any one of the above [9] to [12], wherein the solvent is used in the reducing step (P1) such that the amount of the halosilane raw material (C0) is 0.01 mole or higher and 5.0 mol or lower per 1 L of the solvent.
[14] The method according to any one of the above [1] to [13], wherein a molar concentration of the halosilane raw material (C0) in the reducing step (P1) is 0.150 mol/L or higher.
[15] The method according to any one of the above [1] to [14], wherein a ratio of the molar concentration of the halosilane raw material (C0) to the number of a silicon atom in the halosilane raw material (C0) in the reducing step (P1) is 0.90 mol/L or higher.
[16] The method according to any one of the above [1] to [15], wherein the reaction solution of the reducing step (P1) comprises the hydrogenated polysilane compound (CX) and the reducing agent (B) and/or the resulting material of the reducing agent (B).
[17] The method according to the above [16], wherein the reaction solution of the reducing step (P1) comprises a resulting material of the reducing agent (B), and the resulting material comprises an aluminum complex.
[18] The method according to the above [17], wherein the aluminum complex is a complex of aluminum or aluminum halide and the ether solvent.
[19] The method according to any one of the above [1] to [18], wherein the (T3) contacting step with the acid aqueous solution is (T3X) contacting step of the reaction solution of the reducing step (P1) with the acid aqueous solution.
[20] The method according to the above [19], wherein the (T3X) contacting step of the reaction solution with the acid aqueous solution is carried out after the reducing step (P1) without separating step of a solid and a liquid.
[21] The method according to the above [20], wherein the (T3X) contacting step of the reaction solution with the acid aqueous solution is carried out without both the separation and concentration of the reaction solution after the reducing step (P1).
[22] The method according to any one of the above [19] to [21], wherein the (T3X) contacting step of the reaction solution with the acid aqueous solution and the (T4) distilling step of the hydrogenated polysilane compound (CX) are carried out.
[23] The method according to any one of the above [1] to [22], wherein a concentration of the acid substance in the acid aqueous solution in the (T3) contacting step with the acid aqueous solution is 1% by mass or higher and 60% by mass or lower.
[24] The method according to any one of the above [1] to [23], wherein the acid aqueous solution in the (13) contacting step with the acid aqueous solution comprises at least one selected from hydrochloric acid, sulfuric acid, nitric acid, and phosphoric acid.
[25] The method according to any one of the above [1] to [24], wherein the (T1) separating step of a solid and a liquid is filtering step.
[26] The method according to any one of the above [1] to [25], wherein the removing step of the reducing agent (R2) and/or the resulting material of the reducing agent (R2) is at least two or more of the following steps: the (T1) separating step of a solid and a liquid, the (12) separating step of one liquid and another comprising a reaction solution, a concentrated solution of the reaction solution, or a washing solution of the reaction solution or the concentrated solution of the reaction solution, and the (T3) contacting step with an acid solution.
[27] The method according to the above [26], wherein the removing step of the reducing agent (R2) and/or the resulting material of the reducing agent (R2) comprises:
   two of the (T1) separating step of a solid and a liquid, and the (T2) separating step of one liquid and another comprising a reaction solution, a concentrated solution of the reaction solution, or a washing solution of the reaction solution or the concentrated solution of the reaction solution, or
   two of the (T2) separating step of one liquid and another comprising a reaction solution, a concentrated solution of the reaction solution, or a washing solution of the reaction solution or the concentrated solution of the reaction solution and the (T3) contacting step with an acid aqueous solution.
[28] The method according to the above [26] or [27], further comprising (T4) distilling step of the hydrogenated polysilane compound (CX).
[29] The method according to any one of the above [1] to [25], wherein the removing step of the reducing agent (R2) and/or the resulting material of the reducing agent (R2) is at least one of the (T3) contacting step of the reducing agent (R2) and/or the resulting material of the reducing agent (R2) with the acid aqueous solution and/or the (T4) distilling step of the hydrogenated polysilane compound (CX).
[30] The method according to any one of the above [19] to [29], further comprising contacting step of the mixture obtained in the (T3X) contacting step of the reaction solution with the acid aqueous solution or the layer containing the hydrogenated polysilane compound (CX) with water before the distilling step.
[31] The method according to any one of the above [1] to [30], wherein the polyhalosilane compound (C1) as the halosilane raw material (C0) is produced by contacting step (P3) of the salt of the polyhalosilane compound (C21) with the Lewis acid compound (R3).
[32] The method according to the above [31], wherein the Lewis acid compound (R3) is an aluminum halide compound.
[33] The method according to the above [32], wherein the contact of the salt of the polyhalosilane compound (C21) with the aluminum halide compound is carried out in the presence of a solvent (S2).
[34] The method according to the above [33], wherein the solvent (S2) is one or more solvents selected from the group consisting of a hydrocarbon solvent, an ether solvent, and a halogenated hydrocarbon solvent.
[35] The method according to any one of the above [31] to [34], wherein the salt of the polyhalosilane compound (C21) as the raw material used in the contacting step (P3) for the production of the polyhalosilane compound (C) is obtained by contacting step (P31) of a halogenated monosilane compound (C4) with at least one selected from a phosphonium salt and an ammonium salt (R1).
[36] The method according to any one of the above [1] to [30], wherein the salt of the polyhalosilane compound (C2) as the halosilane raw material (C0) is obtained by contacting step (P4) of the halogenated monosilane compound (C4) with at least one selected from the phosphonium salt and the ammonium salt (R1).
[37] The method according to any one of the above [1] to [30], wherein the complex of the polyhalosilane compound (C3) as the halosilane raw material (C0) is obtained by contacting step (P5) of the halogenated monosilane compound (C4) with a coordination compound.
[38] The method according to the above [37], wherein the coordination compound is at least one selected from the group consisting of the following (i) and (ii).
   (i) compound represented by XRₕ(h=3 when X is P, P═O, or N, and R represents a substituted or unsubstituted alkyl or aryl group, either identically or differently; h=2 when X is S, S═O, or O, and R represents a substituted or unsubstituted alkyl or aryl group, either identically or differently, the number of an amino group in XRₕ is 0 or 1.)
   (ii) substituted or unsubstituted heterocyclic compound containing N, O, S or P with an unshared electron pair in the ring
[39] The method according to any one of the above [1] to [38], wherein the halosilane raw material (C0) is the polyhalosilane compound (C1).
[40] The method according to any one of the above [1] to [39], wherein the polyhalosilane compound (C1) is the cyclic halosilane compound and the hydrogenated polysilane compound (CX) is the cyclic hydrogenated silane compound.
[41] The method according to the above [40], wherein the cyclic hydrogenated silane compound comprises cyclopentasilane or cyclohexasilane.
[42] The method according to the above [40], wherein the cyclic hydrogenated silane compound is cyclohexasilane.
[43] The method according to any one of the above [1] to [42], wherein the polyhalosilane compound (C1) is the cyclic halosilane compound and the hydrogenated polysilane (CX) is the cyclic hydrogenated silane compound, and the (T3X) contacting step of the reaction solution of the reducing step (P1) with the acid aqueous solution is carried out as the (13) contacting step with an acid aqueous solution.
[44] The method according to any one of the above [1] to [30], [36], [39] to [42], wherein
   the halosilane raw material (C0) is the cyclic halosilane compound and the hydrogenated polysilane compound (CX) is the cyclic hydrogenated silane compound,
   the cyclic halosilane compound is formed by contacting step (P3) of the salt of the polyhalosilane compound (C21) with the aluminum halide compound in the presence of the solvent (S2),
   the contact of the reducing step (P1) of the cyclic halosilane compound is carried out in the presence of the solvent (S1),
   the reducing agent (R2) is the metal hydride (E), and the resulting material of the reducing agent (R2) comprises the aluminum complex, and
   the aluminum complex is removed by at least two or more of the following steps: the (T1) filtering step as the separating step of a solid and a liquid, the (T2) separating step of one liquid and another comprising a reaction solution, a concentrated solution of the reaction solution, or a washing solution of the reaction solution or the concentrated solution of the reaction solution, and (T3) contacting step with the acid aqueous solution.
[45] The method according to any one of the above [1] to [35], and [39] to [42], wherein the halosilane raw material (C0) is the polyhalosilane compound (C1),
   the reducing agent (R2) and/or the resulting material of the reducing agent (R2) is a liquid at a temperature of 30° C.,
   the contact of the reducing step (P1) is carried out in a batch reactor in the presence of the solvent (S1), and
   the removing step of the reducing agent (R2) and/or the resulting material of the reducing agent (R2) is at least one of the (T3) contacting step of the reducing agent (R2) and/or the resulting material of the reducing agent (R2) with the acid aqueous solution and the (T4) distilling step of the hydrogenated polysilane compound (CX).
[46] A method for producing a cyclic hydrogenated silane compound comprising
   (A) contacting at least one selected from a cyclic halosilane compound, a salt of the cyclic halosilane compound, and a complex of the cyclic halosilane compound with a reducing agent, and
   (B) contacting a reaction solution obtained in the (A) step with an acid aqueous solution.
[47] The method according to the above [46], further comprising (C) distilling the cyclic hydrogenated silane compound.
[48] The method according to the above [46] or [47], wherein the salt of the cyclic halosilane compound is obtained by (D) contacting step of a halogenated monosilane compound with at least one selected from a phosphonium salt and an ammonium salt.
[49] The method according to any one of the above [46] to [48], wherein the cyclic halosilane compound is obtained by (E) contacting step of the salt of the cyclic halosilane compound with the Lewis acid compound.
[50] The method according to any one of the above [46] to [49], wherein a concentration of the acid substance in the acid aqueous solution is 1% by mass or higher and 60% by mass or lower.
[51] The method according to any one of the above [46] to [50], wherein the acid aqueous solution comprises at least one selected from hydrochloric acid, sulfuric acid, nitric acid, and phosphoric acid.
[52] The method according to any one of the above [46] to [51], wherein the solvent is used in the step (A) such that the total amount of the halosilane raw material and the like is 0.01 mol or higher and 5.0 mol or lower per 1 L of the solvent.
[53] The method according to any one of the above [46] to [52], wherein the step (13) is carried out after the step (A) without separating step of a solid and a liquid.
[54] The method according to any one of the above [1] to [53], wherein the reaction solution of the reducing agent comprises the cyclic hydrogenated silane compound and the aluminum complex.
[55] The method according to the above [54], wherein the aluminum complex is the complex of aluminum or aluminum halide and the ether solvent.
[56] The method according to any one of the above [46] to [55], wherein the step (A) is carried out under the presence of at least one selected from a hydrocarbon solvent and an ether solvent.
[57] The method according to any one of the above [46] to [56], wherein the reducing agent is at least one selected from an aluminum hydride compound, a boron hydride compound, a silane hydride compound, a tin hydride compound, and a transition metal hydride compound.
[58] The method according to any one of the above [46] to [57], wherein the cyclic hydrogenated silane compound comprises cyclopentasilane and cyclohexasilane.
[60] A method for producing a cyclic hydrogenated silane compound comprising
   step 1 in which a salt (A) of a cyclic halosilane compound is contacted with an aluminum halide compound (B) in a solvent (C) to form a cyclic halosilane compound (D),
   step 2 in which the cyclic halosilane compound (D) is contacted with a metal hydride (E) in a solvent (F) to obtain a composition containing a cyclic hydrogenated silane compound (G) and an aluminum complex (H); and
   step 3 in which the aluminum complex is separated,
   wherein the separating of the aluminum complex (H1) is at least two or more of the following steps: (a) filtering step, (b) separating step of one liquid and another comprising a reaction solution, a concentrated solution of the reaction solution, or a washing solution of the reaction solution or the concentrated solution of the reaction solution, and (c) washing step with an acid aqueous solution.
[61] The method according to the above [59], further comprising distilling step of the cyclic hydrogenated silane compound (G).
[62] The method according to the above [59] or [60], wherein a molar concentration of the halosilane raw material (D) in the step 2 is 0.150 mol/L or higher.
[63] The method according to any one of the above [59] to [61], wherein a ratio of the molar concentration of the cyclic halosilane compound (D) to the number of a silicon atom in the cyclic halosilane compound (D) in the step 2 is 0.90 mol/L or higher.
[63] The method according to any one of the above [59] to [62], wherein the separating of the aluminum complex is the (a) separating step of one liquid and another comprising a reaction solution, a concentrated solution of the reaction solution, or a washing solution of the reaction solution or the concentrated solution of the reaction solution, and the (b) filtering step, or the (a) separating step of one liquid and another comprising a reaction solution, a concentrated solution of the reaction solution, or a washing solution of the reaction solution or the concentrated solution of the reaction solution and the (c) washing step with an acid aqueous solution.
[64] The method according to any one of the above [59] to [63], wherein at least one of the solvent (C) and the solvent (F) is the ether solvent.
[65] The method according to any one of the above [59] to [64], wherein the cyclic hydrogenated silane compound (G) comprises cyclopentasilane or cyclohexasilane.
[66] The method according to the above [65], wherein the cyclic hydrogenated silane compound (G) is cyclohexasilane.
[67] A method for preparing a hydrogenated polysilane compound (D) in a batch reactor from a composition comprising a polyhalosilane compound (A) comprising a Si—Si bond and a Si—X bond (X represents a halogen atom) in the same molecule, a reducing agent (B), and a solvent (C), comprising
   (i) contacting at least the polyhalosilane compound (A) with the reducing agent (B) to remove the reducing agent (B) and/or the resulting material of the reducing agent (B) after mixing with the acid aqueous solution, and/or,
   (ii) obtaining the hydrogenated polysilane compound (D) from distillation,
   wherein the reducing agent (B) and/or the resulting material of the reducing agent (B) is a liquid at a temperature of 30° C.
[68] The method according to the above [67], wherein the reducing agent (B) is one of the aluminum hydride compound and the boron hydride compound.
[69] The method according to the above [67] or [68], wherein the reducing agent (B) is the aluminum hydride compound having Al—R¹ (R¹ is an alkyl group that may be branched) or Al—OR² (R² is an alkyl group that may be branched).
[70] The method according to any one of the above [67] to [69], wherein the solvent (C) comprises the hydrocarbon solvent.
[71] The method according to any one of the above [67] to [70], wherein the hydrogenated polysilane compound (D) comprises cyclopentasilane or cyclohexasilane.

### Effect of the Invention

According to the present invention, a high-quality hydrogenated polysilane compound can be produced by reducing process troubles caused by the halosilane raw material and the reducing agent.

According to one aspect of the present invention, a hydrogenated polysilane compound (e.g., a cyclic hydrogenated silane compound) can be safely or efficiently produced because the component derived from the reducing agent (e.g., the aluminum-containing component derived from the reducing agent), the aluminum-containing component used in the synthesis of the halosilane material and not derived from the reducing agent (e.g., the aluminum-containing component derived from the Lewis acid compound), and the resulting material of the reducing agent are prevented from sticking to manufacturing facilities.

According to an aspect of the present invention, complexes (aluminum complexes, etc.) derived from the Lewis acid compound and the reducing agent generated by the reaction of the salt of the polyhalosilane compound (such as the salt of the cyclic halosilane compound) with the Lewis acid compound (such as the aluminum halide compound) or the reaction of the polyhalosilane compound (such as the cyclic halosilane compound or the salt of the cyclic halosilane compound) with the reducing agent can be handled safely and easily, and the hydrogenated polysilane compound (the cyclic hydrogenated silane compound and the like) with reduced amounts of metals (an aluminum and the like) derived from the Lewis acid compound and the reducing agent can be obtained at high purity.

According to an aspect of the present invention, the hydrogenated polysilane compound can be produced stably and efficiently, with almost no solid residue generated when subjected to the reduction reaction.

### MODE FOR CARRYING OUT THE INVENTION

The present invention is described in detail below.

Combinations of two or more of the individual preferred embodiments of the present invention described below are also preferred forms of the invention.

A method for producing a hydrogenated polysilane compound (CX) of the present invention comprises a reducing step (P1) in which at least one of a halosilane raw material (C0) selected from a polyhalosilane compound (C1) containing a Si—Si bond and a Si—X bond (wherein X represents a halogen atom) in the same molecule, a salt of the polyhalosilane compound (C2), and a complex of the polyhalosilane compound (C3) is contacted with a reducing agent (R2), and a removing step in which the reaction solution of the reducing step (P1) is subjected to one or more steps selected from the following (T1) to (T4) to remove the reducing agent (R2) and/or a resulting material of the reducing agent (R2) contained in the reaction solution.
(T1) separating step of a solid and a liquid
(T2) separating step of one liquid and another comprising a reaction solution, a concentrated solution of the reaction solution, or a washing solution of the reaction solution or the concentrated solution of the reaction solution
(T3) contacting step with an acid aqueous solution
(T4) distilling step of a hydrogenated polysilane compound (CX)

The above method solves the problems such as residue formation and pipe adhesion caused by the reducing agent (e.g., the aluminum-containing component derived from the reducing agent), the aluminum-containing component used in the synthesis of the halosilane raw material that is not derived from the reducing agent (e.g., the aluminum-containing component derived from the Lewis acid compound), and the resulting material derived from the reducing agent when the hydrogenated polysilane compound is prepared by using a halosilane raw material and a reducing agent. Then, the above method can reduce process troubles using the halosilane raw material and the reducing agent.

### <Halosilane Raw Material (C0)>

The halosilane raw material ((C0) is at least one of a polyhalosilane compound (C1) containing a Si—Si bond and a Si—X bond (X represents a halogen atom) in the same molecule, a salt of the polyhalosilane compound (C2), or a complex of the polyhalosilane compound (C3), preferably the polyhalosilane compound (C1), a salt of the polyhalosilane compound (C2), or a complex of the polyhalosilane compound (C3).

The polyhalosilane compound (C1), the salt of the polyhalosilane compound (CA and the complex of the polyhalosilane compound (C3) may each be used in one kind or in two or more kinds.

### <Polyhalosilane Compound (C1)>

The polyhalosilane compound (C1) (also called a polyhalosilane compound (A)) used in the present invention contains a Si—Si bond and a Si—X bond (X represents a halogen atom) in the same molecule.

The polyhalosilane compound (C1) may be a cyclic compound or a chain compound containing a halogen atom and a silicon atom in the same molecule.

The number of the silicon atom in the polyhalosilane compound (C1) is not particularly limited, and preferably 3 or more, more preferably 4 or more, even preferably 5 or more, and preferably 8 or less, more preferably 7 or less, and even preferably 6 or less.

When the polyhalosilane compound (C1) is the chain compound, it may have a linear or branched structure.

Among them, the polyhalosilane compound is more preferably a cyclic halosilane compound (a free cyclic halosilane compound). It is further preferred that the cyclic halosilane compound has a structure (a cyclic halosilane structure) in which silicon atoms are linked together to form a monoatomic ring and a halogen atom is bonded to at least one silicon atom comprising the monoatomic ring.

The number of the silicon atom constituting the monoatomic ring is not particularly limited and preferably 3 or more, more preferably 4 or more, even preferably 5 or more, and preferably 8 or less, more preferably 7 or less, and even preferably 6 or less. The cyclic halosilane compound may contain a silicon atom that do not constitute the monoatomic ring, for example, a substituent containing a silicon atom (e.g., a silyl group) may be bonded to a silicon atom comprising the monoatomic ring.

At least one halogen atom is preferably bonded to the monoatomic ring formed from the silicon atoms, more preferably one or two (preferably two) halogen atoms are bonded to each of the silicon atoms comprising the monoatomic ring. The halogen atom is preferably a chlorine atom, a bromine atom, an iodine atom or a fluorine atom, more preferably a chlorine atom or a bromine atom, and even preferably a chlorine atom.

The free cyclic halosilane means, for example, a non-complex cyclic halosilane such as Si₅Cl₁₀, Si₆Cl₁₂ or such as Si₆Cl₁₁H partially substituted with a hydrogen atom.

The polyhalosilane compound (preferably the cyclic halosilane compound) may contain a silicon atom that does not constitute a monoatomic ring, for example, a substituent containing a silicon atom (e.g., a silyl group) may be bonded to a silicon atom that constitutes a monoatomic ring. However, when a silicon atom that does not constitute a monoatomic ring is included, the amount of silane gas may be increased and the yield of the cyclic hydrogenated silane compound may be lowered during storage of the cyclic halosilane compound and the salt thereof or in the process of reducing the resulting polyhalosilane compound (preferably the cyclic halosilane compound) to produce a hydrogenated polysilane compound (preferably the cyclic hydrogenated silane compound). Therefore, it is preferable that the silicon atom that do not constitute a monoatomic ring is not contained as much as possible.

It is preferred that at least one halogen atom is bonded to the monoatomic ring formed from silicon atoms, it is more preferred that one or two halogen atoms are bonded to each of the silicon atoms comprising the monoatomic ring, and it is even preferred that two halogen atoms are bonded to each of the silicon atoms comprising the monoatomic ring.

The polyhalosilane compound (preferably the cyclic halosilane compound) of the present invention can be represented, for example, by the following general formula (1).

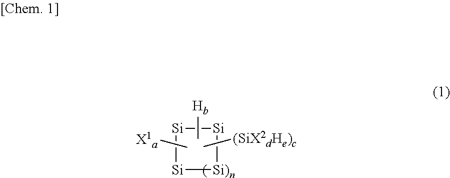

In the above general formula (1), X¹ and X² each independently represent a halogen atom, n represents the number from 0 to 5, a represents the number from 1 to 2n, b and c each represent the number from 0 to 2n−1 (where a +b+c=2n), d and e each represent the number from 0 to 3 (where d+e is 3).

In the formula (1), “a” represents the number of a halogen atom bonded to a silicon atom constituting the ring, “b” represents the number of a hydrogen atom bonded to a silicon atom constituting the ring, and “c” represents the number of —SiX²_{d}Hₑ group bonded to a silicon atom constituting the ring.

For example, in the case where n is 3, a ring structure contained in the cyclic halosilane compound of the present invention is a six-membered ring structure containing six silicon atoms. “d” represents the number of a halogen atom bonded to a silicon atom of —SiX²_{d}Hₑ group, and “e” represents the number of a hydrogen atom bonded to a silicon atom of —SiX²_{d}Hₑ group.

In the above general formula (1), n is preferably 2 or more, and preferably 4 or less. In the above general formula (1), a is preferably 10 or more, and 14 or less. In the above general formula (1), c is preferably 1 or less and more preferably 0. In the above general formula (1), d is more preferably 3.

In the above general formula (1), the halogen atoms of X¹ and X² include a chlorine atom, a bromine atom, an iodine atom and a fluorine atom, preferably a chlorine atom and a bromine atom, and more preferably a chlorine atom. When X¹ and/or X² are multiple, each may be identical or different.

The polyhalosilane compound (preferably the cyclic halosilane compound) of the present invention includes decachlorocyclopentasilane, trichlorosilyl-nonachlorocyclopentasilane, dodecachlorocyclohexasilane, trichlorosilyl-undecachlorocyclohexasilane, tetradecachlorocycloheptasilane, trichlorosilyl-tridecachlorocycloheptasilane, Si₅Cl₉—Si₅Cl₉, Si₆Cl₁₁—Si₆Cl₁₁, Si₇Cl₁₃—Si₇Cl₁₃ and the like. Decachlorocyclopentasilane or dodecachlorocyclohexasilane is more preferred.

The polyhalosilane compound (C1) as the halosilane raw material (C0) is preferably produced by contacting step (P3) of the salt of the polyhalosilane compound (C21) with the Lewis acid compound (R3).

In an aspect of the present invention, the cyclic halosilane compound is obtained by (E) contacting step of the salt of the cyclic halosilane compound with the Lewis acid compound.

The Lewis acid compound (R3) is preferably a metal halide compound.

Examples of the metal element constituting the metal halide compound include group 13 elements such as boron, aluminum, gallium, indium and thallium; group 11 elements such as copper, silver and gold; group 4 elements such as titanium and zirconium; iron, zinc, calcium and others.

Specific examples of the Lewis acid compound include boron halides such as boron trifluoride, boron trichloride and boron tribromide; aluminum halides such as aluminum chloride and aluminum bromide; gallium halides such as gallium chloride and gallium bromide; indium halides such as indium chloride and indium bromide; thallium halides such as thallium chloride and thallium bromide; copper halides such as copper chloride and copper bromide; silver halides such as silver chloride and silver bromide; gold halides such as gold chloride and gold bromide; titanium halides such as titanium chloride and titanium bromide; zirconium halides such as zirconium chloride and zirconium bromide; iron halides such as iron chloride and iron bromide; zinc halides such as zinc chloride and zinc bromide; calcium halides such as calcium chloride and calcium bromide; and others.

In particular, the Lewis acid compound (R3) is more preferably an aluminum halide compound (also called aluminum halide compound (B)).

The aluminum halide compound includes a Lewis acid compound such as an aluminum fluoride compound, an aluminum chloride compound, an aluminum bromide compound, an aluminum iodide compound.

The above aluminum halide compound is preferably an aluminum chloride compound and an aluminum bromide compound, and more preferably an aluminum chloride compound in terms of reactivity and ease of controlling the reaction.

The following compounds may be used in combination with the aluminum halide compound as long as the effects of the present invention are exhibited.

Specifically, examples thereof include titanium halide such as titanium chloride and titanium bromide; zirconium halide such as zirconium chloride and zirconium bromide; copper halide such as copper chloride and copper bromide; silver halide such as silver chloride and silver bromide; gold halide such as gold chloride and gold bromide; boron halide such as boron trifluoride, boron trichloride, and boron tribromide; gallium halide such as gallium chloride and gallium bromide; indium halide such as indium chloride and indium bromide; thallium halide such as thallium chloride and thallium bromide; calcium halide such as calcium chloride and calcium bromide; iron halide such as iron chloride and iron bromide; zinc halide such as zinc chloride and zinc bromide.

The amount of the Lewis acid compound used in the (P3) step or the (E) step can be adjusted according to the reactivity of the salt of the polyhalosilane compound (preferably the cyclic halosilane compound) with the Lewis acid compound. The amount of the Lewis acid compound is preferably 0.5 mol or more, more preferably 1.5 mol or more, and preferably 20 mol or less, more preferably 10 mol or less per 1 mol of the salt of the polyhalosilane compound (preferably the cyclic halosilane compound).

The contact of the salt of the polyhalosilane compound (C21) with the aluminum halide compound may be carried out in the presence of a solvent (S2) or a medium for dispersion (hereinafter simply referred to as solvent).

It is preferred that the solvent (S2) (hereinafter referred to as solvent (C) or reaction solvent (I)) is an organic solvent.

The solvent (S2) is preferably at least one selected from the group consisting of a hydrocarbon solvent, an ether solvent and a halogenated hydrocarbon solvent. The aforementioned solvent (S2) includes a hydrocarbon solvent such as an aliphatic hydrocarbon solvent such as hexane, heptane, octane, nonane, and decane; an aromatic hydrocarbon solvent such as benzene and toluene; an ether solvent such as diethyl ether, dibutyl ether, tetrahydrofuran, cyclopentyl methyl ether, diisopropyl ether, and methyl tertiary butyl ether; a halogenated hydrocarbon solvent such as dichloromethane and dichloroethane, and so on. Among these, the hydrocarbon solvent is preferred, the aliphatic hydrocarbon solvent is more preferred from the point of separation from the metal salt after the reaction, and hexane and heptane are even preferred. The organic solvent may be used individually or in combination of two or more. The reaction solvent may be purified by distillation or dehydration prior to the reaction to remove water and dissolved oxygen contained therein.

The amount of the solvent (S2) used is preferably 1 to 1000 parts by mass, more preferably 10 to 800 parts by mass, and even more preferably 100 to 600 parts by mass per 100 parts by mass of the salt of the polyhalosilane compound (preferably the cyclic halosilane compound) and the aluminum halide compound.

The used amount of the solvent in the step (P3) or the step (E) is not particularly limited, and it is usually preferably adjusted so that the concentration of the salt of the polyhalosilane compound (preferably the cyclic halosilane compound) is 0.005 mol/L or higher and 10 mol/L or lower, more preferably 0.01 mol/L or higher and 5 mol/L or lower, even preferably 0.05 mol/L or higher and 3 mol/L or lower, and even more preferably 0.05 mol/L or higher and 1 mol/L or lower.

The reaction temperature in the step (P3) or the step (E) may be appropriately adjusted depending on the reactivity, and is preferably −80° C. or higher, more preferably −50° C. or higher, even preferably −30° C. or higher, and preferably 200° C. or lower, more preferably 150° C. or lower, and even preferably 100° C. or lower.

The reaction time of the above step (P3) or the step (E) may be appropriately set according to the reaction temperature and the degree of progress of the reaction. For example, the reaction time is preferably 1 hour or longer, more preferably 2 hours or longer, and even preferably 3 hours or longer. The reaction time can be 24 hours or shorter. The reaction time is more preferably 20 hours or shorter, and even preferably 15 hours or shorter.

The heating and/or stirring may be carried out to accelerate the above reaction.

The atmosphere upon carrying out the reaction in the step (P3) or the step (E) is not particularly restricted, and from the viewpoint of suppressing oxidation of the polyhalosilane compound (preferably the cyclic halosilane compound) and the salt thereof, the oxygen concentration in the atmosphere is preferably 9% by volume or lower, more preferably 5% by volume or lower, even preferably 3% by volume or lower, and particularly preferably 1% by volume or lower. In addition, from the viewpoint of suppressing hydrolysis of the polyhalosilane compound (preferably the cyclic halosilane compound) and the salt thereof, the moisture concentration in the atmosphere is preferably 2000 ppm (volumetric basis) or lower, more preferably 1500 ppm (volumetric basis) or lower, even preferably 1000 ppm (volumetric basis) or lower, more even preferably 500 ppm (volumetric basis) or lower, furthermore even preferably 150 ppm (volumetric basis) or lower, and particularly preferably 10 ppm (volumetric basis) or lower. The step (E) may be carried out in an atmosphere of an inert gas (e.g., nitrogen gas or argon gas), and may be carried out under light shielding condition.

In the step (P3) or the step (E), the method for contacting the salt of the polyhalosilane compound (preferably the cyclic halosilane compound) with the Lewis acid compound is not particularly limited, and includes (1) a method for dissolving or dispersing each of the salt of the polyhalosilane compound (preferably the cyclic halosilane compound) and the Lewis acid compound in a solvent beforehand to prepare a solution (or dispersion) of the salt of the polyhalosilane compound (preferably the cyclic halosilane compound) and a solution (or dispersion) of the Lewis acid compound, and then mixing these solutions (or dispersions), (2) a method for simultaneously or sequentially adding the salt of the polyhalosilane compound (preferably the cyclic halosilane compound) and the Lewis acid compound to the solvent, (3) a method for adding the Lewis acid compound to a solution (or dispersion) of the salt of the polyhalosilane compound (preferably the cyclic halosilane compound), and (4) a method for adding the salt of the polyhalosilane compound (preferably the cyclic halosilane compound) and the Lewis acid compound, and then adding a solvent thereto.

The salt of the polyhalosilane compound (preferably the cyclic halosilane compound) used in the step (P3) or the step (E) can be produced, for example, in a step (P4) or a step (D) described below. In such a case, as a solution (or dispersion) of the salt of the polyhalosilane compound (preferably the cyclic halosilane compound), the reaction solution of the step (P4) or the step (D) may be used as it is, or a solution (or dispersion) in which solid-liquid separation or solvent substitution is carried out after the step (P4) or the step (D) may be used. The salt of the polyhalosilane compound (preferably the cyclic halosilane compound) used in the step (P3) or the step (E) can be the salt of the polyhalosilane compound (preferably the cyclic halosilane compound) obtained by any method, such as by contacting the halosilane compound with an ammonium salt or a phosphonium salt, or by contacting the halosilane compound with a tertiary polyamine.

In the step (P3) or the step (E), one or both of the salt of the polyhalosilane compound (preferably the cyclic halosilane compound) and the Lewis acid compound may be added in a batch, and sequential addition of one or both of the salt of the polyhalosilane compound (preferably the cyclic halosilane compound) and the Lewis acid compound is preferred. Sequential addition may be divided addition and is preferably continuous addition.

The step (P3) or the step (E) may be a reaction in a batch reactor or in a continuous reactor. When the step (P3) or the step (E) is carried out in a batch reaction, it is preferred that the Lewis acid compound is added sequentially to the solution (or dispersion) of the salt of the polyhalosilane compound (preferably the cyclic halosilane compound).

The salt of the polyhalosilane compound (C21) includes the same compounds as set forth below. The salt of the polyhalosilane compound (C21) is a raw material used in the contacting step (P3) for the production of the polyhalosilane compound (C1) and may be obtained by contacting step (P31) of a halogenated monosilane compound (C4) with at least one selected from the phosphonium salt and the ammonium salt (R1).

Examples of the halogenated monosilane compound ((4) include trihalogenated silanes such as trichlorosilane, tribromosilane, triiodosilane and trifluorosilane; dihalogenated silanes such as dichlorosilane, dibromosilane, diiodosilane and difluorosilane; tetrahalogenated silanes such as tetrachlorosilane, tetrabromosilane, tetraiodosilane and tetrafluorosilane; and others. Among them, trihalogenated silane is preferable, and trichlorosilane is more preferable.

The halogenated monosilane compound is contacted with at least one selected from the phosphonium salt and the ammonium salt for a cyclization coupling reaction of the halogenated monosilane compound, and the salt of the polyhalosilane compound (preferably the cyclic halosilane compound) containing a ring formed by linking silicon atoms of the halogenated monosilane compound can be obtained. In this case, the salt of the polyhalosilane compound (preferably the cyclic halosilane compound) has an advantage that the generation of silane gas derived from the counter cation can be suppressed in the subsequent process because the salt has a phosphonium ion or an ammonium ion as the counter cation (i.e., a phosphonium salt or ammonium salt), and the counter cation does not contain a silicon atom.

The phosphonium salt is preferably a quaternary phosphonium salt, and is more preferably a salt represented by the following formula (2). The ammonium salt is preferably a quaternary ammonium salt, and more preferably a salt represented by the following formula (3). In the formulas (2) and (3), embodiments of R¹ to R⁴ and preferred embodiments thereof are the same as in the formulas (4) and (5) as set forth below, unless otherwise mentioned, and A-represents a monovalent anion.

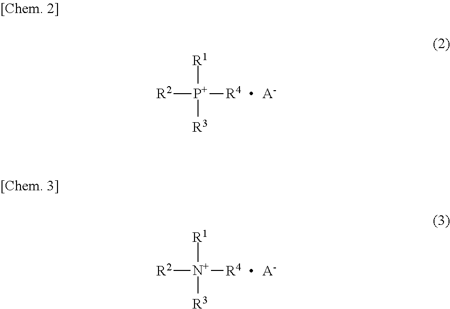

Examples of the monovalent anion represented by A⁻ in the formulas (2) and (3) include a halide ion (e.g., Cl⁻, Br⁻, I⁻ and others), a borate ion (e.g., BF₄⁻), a phosphorus anion (for example, PF₆⁻), and others. Among them, from the viewpoint of ease of availability, Cl⁻, Br⁻ and I⁻ are preferable, and Cl⁻ and Br⁻ are particularly preferable.

One or both of the phosphonium salt and the ammonium salt may be used. The phosphonium salt may be used individually or in combination of two or more. The ammonium salt may be used individually or in combination of two or more. The coupling agent other than phosphonium salts and ammonium salts may be used in combination in the step. Other coupling agent includes a tertiary polyamine such as N,N,N′,N″,N″-pentamethyldiethylenetriamine (pedeta), N,N,N′,N′-tetramethylethylenediamine (teeda), and an onium salt other than phosphonium and ammonium salts. In this case, the amount of other coupling agent is preferably 0 to 10% by mol of the total amount of phosphonium and ammonium salts since there is a tendency to improve the handling of the salt of the polyhalosilane compound (preferably the cyclic halosilane compound).

By using the phosphonium salt represented by the formula (2) or the ammonium salt represented by the formula (3), the salt of the polyhalosilane compound (preferably the cyclic halosilane compound) can be obtained, and in particular, the salt of the polyhalosilane compound (preferably the cyclic halosilane compound) containing a six-membered silicon homocyclic ring and containing no silicon atom other than silicon atoms constituting the homocyclic ring can be easily obtained. For example, in the case that trichlorosilane is used as the halogenated monosilane compound and a phosphonium salt represented by the formula (2) in which R1 to R⁴ are phenyl groups and A⁻ is chlorine ion (Cl⁻) is used as the phosphonium salt, a salt of a polyhalosilane compound (preferably a cyclic halosilane compound) dianion and a phosphonium ion such as dodecachlorodihydrocyclohexasilane dianion ([Ph₄P⁺]₂[Si₆H₂Cl₁₂]²⁻) salt, tridecachlorohydrocyclohexasilane dianion ([Ph₄P⁺]₂[Si₆HCl₁₃]²⁻) salt and tetradecachlorocyclohexasilane dianion ([Ph₄P⁺]₂[Si₆Cl₁₄]²⁻) salt is obtained.

The used amount of the phosphonium salt and/or the ammonium salt in the step (P31), that means a total used amount thereof in the case where two or more kinds of the salt are used, is preferably 0.01 mol or more, more preferably 0.05 mol or more, even preferably 0.08 mol or more, and preferably 1.0 mol or less, more preferably 0.7 mol or less, even preferably 0.5 mol or less, per 1 mol of the halosilane compound. When the amount of the phosphonium salt and/or the ammonium salt is too small, the yield of the salt of the cyclic halosilane compound is likely to decrease.

The step (P31) is preferably carried out in the presence of a basic compound. Examples of the basic compound include, for example, (mono-, di-, tri-, poly-)amine compounds, and among them, a monoamine compound is preferably used. Specifically, triethylamine, tripropylamine, tributylamine, trioctylamine, triisobutylamine, triisopentylamine, diethylmethylamine, diisopropylethylamine, dimethylbutylamine, dimethyl-2-ethylhexylamine, diisopropyl-2-ethylhexylamine, methyldioctylamine and others are preferable, and tributylamine and diisopropylethylamine are particularly preferable. The basic compound may be used individually or in combination of two or more kinds.

The used amount of the basic compound in the step (P31), that means a total used amount thereof in the case where two or more kinds of that are used, may be appropriately adjusted according to the kind thereof or the like. For example, the amount of the basic compound is preferably 0.1 mol or more, more preferably 0.2 mol or more, even preferably 0.4 mol or more, and preferably 2 mol or less, more preferably 1.8 mol or less, even preferably 1.5 mol or less, per 1 mol of the halogenated monosilane compound. When the amount of the basic compound is within the above range, the yield of the salt of the polyhalosilane compound (preferably the cyclic halosilane compound) is likely to increase. When a diamine compound, a triamine compound or a polyamine compound can be used as the basic compound, the used amount (or the total used amount) of the basic compound (di-, tri-, poly-amine) is preferably 0.5 mol or less, more preferably 0.4 mol or less, and even preferably 0.3 mol or less, per 1 mol of the halogenated monosilane compound.

The step (P31) may be carried out in the presence of a chelating ligand such as a polyether compound such as 1,1-dimethoxyethane, 1,2-diphenoxyethane; a polythioether compound; a multidentate phosphine compound such as 1,2-bis(dimethyiphosphino)ethane, 1,3-bis(diphenylphosphino)propane. In the case where the step (P31) is carried out in the presence of the chelating ligand, there is a tendency to improve the yield of the salt of the polyhalosilane compound (preferably the cyclic halosilane compound). It is also possible to adjust the number of a hydrogen atom and a composition ratio in the resulting polyhalosilane compound (preferably the cyclic halosilane compound) by appropriately selecting the type of the chelating ligand to be used. The amount of chelating ligand used may be set as desired, and, for example, 0.01 mol or more, 0.05 mol or more, or 0.1 mol or more per 1 mol of the halogenated monosilane compound. The amount of the chelating ligand may be 50 mol or less, 40 mol or less, or 30 mol or less per 1 mol of the halogenated monosilane compound.

The step (P31) is preferably carried out in the presence of a solvent. As the solvent, an organic solvent is preferably used. As the organic solvent, a solvent which does not interfere with the cyclization coupling reaction is preferably used, and preferable examples of the organic solvent include, for example, halogenated hydrocarbon solvents such as chloroform, dichloromethane and 1,2-dichloroethane; ether solvents such as diethyl ether, tetrahydrofuran, cyclopentyl methyl ether, diisopropyl ether and methyl tertiary-butyl ether; aprotic polar solvents such as acetonitrile, ethyl acetate, and N, N-dimethylformamide. Among them, chlorinated hydrocarbon solvents such as chloroform, dichloromethane and 1,2-dichloroethane are preferably used, and dichloromethane and 1,2-dichloroethane are particularly preferable.

The amount of the solvent used for the step (P31) is not particularly limited, and usually, it is adjusted so that the concentration of the polyhalosilane compound (preferably the cyclic halosilane compound) is preferably 0.5 mol/L to 10 mol/L, more preferably 0.8 mol/L to 8 mol/L, and even more preferably 1 mol/L to 5 mol/L.

The reaction temperature in the step (P31) may be appropriately adjusted according to the reactivity, and is, for example, about 0° C. to 120° C., and preferably about 15° C. to 70° C. The reaction temperature means a solution temperature in the reactor. For adjusting the reaction temperature, a medium for temperature adjustment may be supplied in a jacket provided around the reactor, for example, though it is not limited thereto. The reaction time may be appropriately adjusted according to the reaction temperature and the progress of the reaction, and is preferably 1 hour or longer, more preferably 2 hours or longer, even more preferably 3 hours or longer, and preferably 48 hours or shorter, more preferably 24 hours or shorter. During the reaction, stirring may be conducted simultaneously with heating in order to accelerate the reaction.

It is desirable that the reaction of the step (P31) is carried out under substantially anhydrous conditions, and it is preferable to be carried out under an atmosphere of a dry gas (especially an inert gas such as nitrogen gas and argon gas), for example.

In the step (P31), the method for contacting the halogenated monosilane compound with at least one selected from the phosphonium salt and the ammonium salt is optional. Examples thereof includes (1) a method for adding at least one selected from the phosphonium salt and the ammonium salt to a reactor in advance, and sequentially adding the halogenated monosilane compound, (2) a method for adding the halogenated monosilane compound to a reactor in advance, and sequentially adding at least one selected from the phosphonium salt and the ammonium salt, and (3) a method for sequentially adding each of the halogenated monosilane compound and at least one selected from the phosphonium salt and the ammonium salt to a reactor, and the like. The step (P31) is preferably carried out by the above (1) method.

When the solvent is used in the step (P31), one or both of the halogenated monosilane compound and at least one selected from the phosphonium salt and the ammonium salt may be dissolved or dispersed in the solvent in advance before contacting the halogenated monosilane compound with at least one selected from the phosphonium salt and the ammonium salt, without any particular limitation.

Preferably, at least one selected from the phosphonium salt and the ammonium salt is dissolved or dispersed in the solvent beforehand.

The salt of the polyhalosilane compound (preferably the cyclic halosilane compound) obtained in the step (P31) can be isolated from the reaction solution by using purification methods such as solid-liquid separation, distillation, crystallization and extraction. In particular, when the substituents R¹ to R⁴ of the phosphonium salt or the ammonium salt are alkyl group or aryl group, the salt of the polysilane compound (preferably the cyclic halosilane compound) tends to precipitate in the reaction solution, and thus the salt of the cyclic halosilane compound can be easily purified by solid-liquid separation. The solid-liquid separation is not particularly limited, and known solid-liquid separations such as filtration, precipitation separation, centrifugation, and decantation can be used.

### <Salt of Polyhalosilane Compound (Preferably Cyclic Halosilane Compound) (C2)>

In the present invention, the salt of the polyhalosilane compound (preferably the cyclic halosilane compound) has an anionic moiety containing a ring structure containing one or more Si atoms and one or more S1-halogen atom bonds and a counter cationic moiety, and the ring structure may have a substituent. The salt of the polyhalosilane compound is hereinafter referred to as a salt of the cyclic halosilane compound of the present invention. The number of Si atoms in one molecule in the salt of the polyhalosilane compound (preferably the cyclic halosilane compound) of the present invention is preferably 3 or more, more preferably 4 or more or 5 or more, preferably 14 or less, more preferably 8 or less or 7 or less, and even preferably 6 or less. The salt of the cyclic halosilane compound is preferably a salt compound that contains a silicon monoatomic ring and has a structure in which a halogen atom is bonded to at least one silicon atom comprising the monoatomic ring. The halogen atom includes a fluorine atom, a chlorine atom, a bromine atom, and an iodine atom.

The salt of the polyhalosilane compound (preferably the cyclic halosilane compound) may contain any structure as a counter cationic moiety. The above counter cationic moieties include, for example, an onium (e.g., a phosphonium ion and an ammonium ion); a polyamine SiH₂Cl⁺ such as N,N,N′,N″,N″-pentamethyldiethylenetriamine (pedeta) SiH₂Cl⁺, N,N,N′,N′-tetramethylethylenediamine (teeda) SiH₂C1.

The salt of the polyhalosilane compound (preferably the cyclic halosilane compound) is preferably a phosphonium salt or an ammonium salt. The salt of the polyhalosilane compound (preferably the cyclic halosilane compound) contains preferably the structure represented by the following general formula (4) or (5) as the counter cationic moiety.

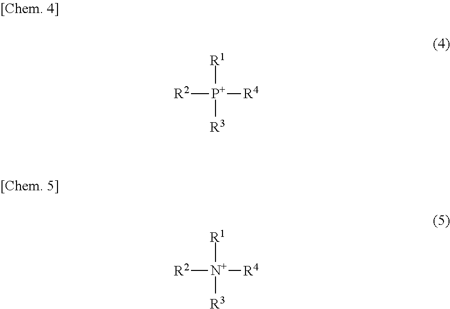

In formula (4) or (5), R¹ to R⁴ each independently represent a hydrogen atom, an alkyl group which may have a substituent, or an aryl group which may have a substituent. In formula (4) or (5), R¹ to R⁴ may be different from each other, and all of R³ to R¹ is preferably the same group. The alkyl group is preferably an alkyl group having 1 to 16 carbons, such as methyl, ethyl, propyl, butyl, pentyl, hexyl, heptyl, octyl, cyclohexyl, and the alkyl group is more preferably an alkyl group having 1 to 8 carbons. The aryl group is preferably an aryl group having 6 to 18 carbons such as phenyl group and naphthyl group, and more preferably an aryl group having 6 to 12 carbons. There are no particular restrictions on the substituents above, and the substituent includes a halogen atom, an alkyl group, an aryl group, an alkoxy group, and a hydroxyl group.

R¹ to R⁴ are preferably an alkyl group or an aryl group, more preferably an aryl group in the formula (4), and more preferably an alkyl group in the formula (5), as these tend to facilitate the production of salts of highly pure polyhalosilane compound (preferably the cyclic halosilane compound). As a counter cation, an ammonium ion is preferred than a phosphonium ion.

For example, a halogenated monosilane compound is contacted with at least one of the phosphonium salt and the ammonium salt for a cyclization coupling reaction of the halogenated monosilane compound, and the salt of the polyhalosilane compound (preferably the cyclic halosilane compound) containing a ring formed by linking silicon atoms of the halogenated monosilane compound can be obtained. In this case, the salt of the polyhalosilane compound (preferably the cyclic halosilane compound) has an advantage that the generation of silane gas derived from the counter cation is suppressed in the subsequent process because the salt has a phosphonium ion or an ammonium ion as the counter cation (i.e., a phosphonium salt or ammonium salt), and the counter cation does not contain a silicon atom.

The salt of the polyhalosilane compound (preferably the cyclic halosilane compound) of the present invention may be represented, for example, by the following general formula (6).

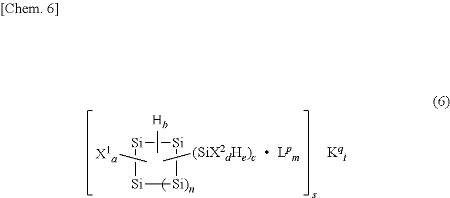

In the above formula (6), X¹ and X² each independently represent a halogen atom, L represents an anionic ligand, p represents an integer from −2 to −1 as the valence of the ligand L, K represents a counter cation, q represents an integer from +1 to +2 as the valence of the counter cation K, n represents an integer from 0 to 5, a, b and c represent each independently an integer from 0 to 2n+6, respectively (where a+b+c=2n+6 and a and c are not 0 simultaneously), d represents an integer from 0 to 3 (where a and d are not 0 simultaneously), e represents an integer from 0 to 3 (where d+e=3), m is from 1 to 2, and s represents an integer greater than or equal to 1, and t represents an integer greater than or equal to 1.

In the above formula (6), n represents the number of a silicon atom constituting the monoatomic ring, and n is an integer from 0 to 5, preferably 1 or more, more preferably 2 or more, and preferably 4 or less, and more preferably 3 or less. n is especially preferred to be 3, i.e. the compound represented by formula (6) is preferably a six-membered silicon monoatomic ring.

In the above formula (6), X¹ represents a halogen atom bonded to a silicon atom constituting the ring, and X² represents a halogen atom of a silyl group bonded to a silicon atom constituting the ring. The halogen atom of X¹ and X² includes a fluorine atom, a chlorine atom, a bromine atom and an iodine atom, preferably a chlorine atom or a bromine atom, and more preferably a chlorine atom. When X are multiple, the plurality of X¹ may be the same or different. When X² are multiple, the plurality of X² may be the same or different.

In the above formula (6), a represents the number of a halogen atom bonded to a silicon atom comprising the ring, b represents the number of a hydrogen atom bonded to a silicon atom comprising the ring, and c represents the number of a silyl group bonded to a silicon atom comprising the ring. d represents the number of a halogen atom of the silyl group bonded to a silicon atom constituting the ring, and e represents the number of a hydrogen atom of the silyl group bonded to a silicon atom constituting the ring. When c is 2 or more, multiple silyl groups bonded to the silicon atom constituting the ring may be the same or different. a, b and c represent an integer of 0 to 2 n+6 (where a+b+c=2n+6, and a and c are not 0 simultaneously). It is preferred that a is an integer from 1 to 2n+6 and each of b and c is an integer from 0 to n+5. It is more preferred that a is an integer from n+6 to 2n+6 and each of b and c is an integer from 0 to n. In the above general formula (6), a is preferably 10 or more, and more preferably 14 or less. In the above general formula (6), c is preferably 1 or less, and more preferably 0. In the above general formula (6), d is more preferably 3.

It is even preferred that c is 0 in the above formula (6) because side reactions such as coupling reactions when reacting with aluminum halide compounds can be suppressed, storage stability of the salt of the polyhalosilane compound (preferably the cyclic halosilane compound) and the polyhalosilane compound (preferably the cyclic halosilane compound) made from the salt can be improved, the generation of silane gas is suppressed in the process of reducing the resulting polyhalosilane compound (preferably the cyclic halosilane compound) to produce the hydrogenated polysilane compound (preferably the cyclic hydrogenated silane compound), and the yield of the hydrogenated polysilane compound (preferably the cyclic hydrogenated silane compound) is improved. It is also particularly preferred that a is 2n+6 and each of b and c is 0.

In the above formula (6), L represents an anionic ligand coordinated to the silicon atom constituting the ring, p represents the valence of the ligand L (an integer of −2 to −1), and m represents the number of ligands L (+1 to −2). The anionic ligand includes a halide ion, a nitrate ion, a cyanide ion and the like.

In the above formula (6), K represents a counter cation, q represents a valence of the counter cation K (integer from +1 to +2), and the values of s and t are determined according to the valence and number of the ligand L and the valence of the counter cation K, respectively.

The above counter cation K includes an onium (e.g., a phosphonium ion and an ammonium ion), a polyamine SiH₂Cl⁻ (e.g., pedeta SiH₂Cl⁺, teeda SiH₂Cl⁺) and the like. When the above counter cation K is an onium, the yield of the polyhalosilane compound (preferably cyclic halosilane compound) is improved by contacting the salt of the polyhalosilane compound (preferably the cyclic halosilane compound) with the onium, so that the counter cation is preferably the onium.

The phosphonium ion represented by the above formula (4) or the ammonium ion represented by the above formula (5) is preferred as the oniums of the above counter cation K.

R¹ to R⁴ in the above formula (4) and R⁵ to R⁸ in the above formula (5) each independently represent a hydrogen atom, an alkyl group, or an aryl group. In the above formula (4), R¹ to R⁴ may be different from each other, all of R¹ to R⁴ is preferably the same group. In the above formula (5), R⁵ to R⁸ may be different from each other, and all of R⁵ to R⁸ is preferably the same group.

The alkyl group of R¹ to R⁴ and R⁵ to R⁸ above is preferably an alkyl group of 1 to 16 carbon atoms such as methyl, ethyl, propyl, butyl, pentyl, hexyl, heptyl, octyl, and cyclohexyl. The alkyl group of R⁵ to R⁸ and R⁵ to R⁸ above is more preferably an alkyl group of 1 to 8 carbon atoms.

The aryl group of R¹ to R⁴ and R⁵ to R⁸ above is preferably an aryl group of 6 to 18 carbon atoms such as phenyl group and naphthyl group and the aryl group of R¹ to R⁴ and R⁵ to R⁸ above is more preferably an aryl group of 6 to 12 carbon atoms. The above R to RV and above R⁵ to R⁸ are preferably an alkyl or an aryl group, and R¹ to R⁴ in the above formula (4) are more preferably an aryl group and R⁵ to R¹ in the above formula (5) are more preferably an alkyl group.

The salt of the polyhalosilane compound (preferably the cyclic halosilane compound) represented by the above formula (6) includes a salt of tetradecachlorocyclohexasilane dianion complex ([Si₆Cl₁₄²⁻]), a salt of tetradecabromocyclohexasilane dianion complex ([Si₆Br₁₄²⁻]) and the like. The counter ion of the polyhalosilane compound is preferably a phosphonium ion or an ammonium ion.

The salt of the polyhalosilane compound (preferably the cyclic halosilane compound) represented by the above formula (6) is preferably a compound represented by the following formula (7) or (8). When such a compound is used as the salt of the polyhalosilane compound (preferably the cyclic halosilane compound), the formation of byproducts and the generation of silane gas of a spontaneously combustible gas are suppressed when the salt of the polyhalosilane compound (preferably the cyclic halosilane compound) is reacted with an aluminum halide compound, so that the polyhalosilane compound (preferably the cyclic halosilane compound) can be easily produced. In addition, the resulting polyhalosilane compound (preferably the cyclic halosilane compound) can be reduced to efficiently produce a hydrogenated polysilane compound (preferably cyclic hydrogenated silane compound).

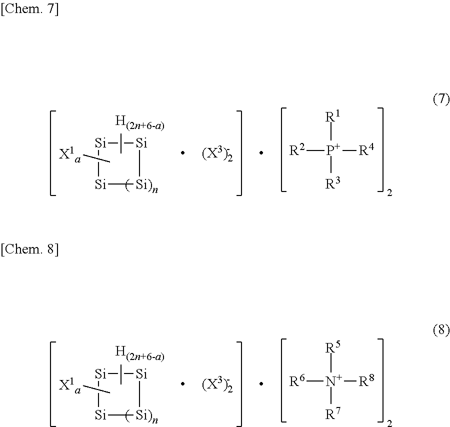

In the above formulas (7) and (8), X, R¹ to R⁴, R⁵ to R⁸, n and a have the same meaning as above, and X³ represents a halogen atom. X³ is present in the form of an ion in the above formula s (7) and (8) and is a halide ion.

The halogen atom in X³ above includes a fluorine atom, a chlorine atom, a bromine atom, and an iodine atom, preferably a chlorine atom or a bromine atom, and more preferably a chlorine atom.

When X³ above are multiple, the plurality of X³ may be identical or different.

X¹ and X³ above may be the same or different. When X and X³ are all chlorine atoms in the above formulas (7) and (8), the hydrogenated polysilane compound (preferably the cyclic hydrogenated silane compound) can be produced at low cost.

In the above formulas (7) and (8), n represents an integer from 0 to 5 and a represents an integer from 1 to 2n+6. n is particularly preferably 3 and a is preferably 6 or more, more preferably 9 or more, and particularly preferably 12 or more.

The salt of the above-mentioned polyhalosilane compound (preferably the cyclic halosilane compound) may be produced by contacting a halosilane compound (preferably a monohalogenated silane, more preferably a trihalogenated silane, even preferably a trichlorosilane) with a tertiary polyamine or by contacting a halosilane compound with at least one of a phosphonium salt (preferably a quaternary phosphonium salt) and an ammonium salt (preferably a quaternary ammonium salt). The salt of the above-mentioned polyhalosilane compound is preferably prepared by contacting a halosilane compound with at least one of a phosphonium salt and an ammonium salt (hereinafter called the cyclization coupling step).

For example, when trichlorosilane is used as the halosilane compound and the phosphonium salt is used, the salt of the polyhalosilane compound (preferably the cyclic halosilane compound) dianion and a phosphonium ion such as dodecachlorodihydrocyclohexasilane dianion salt (e.g. [Ph₄P⁺]₂[Si₆H₂Cl₁₂]²⁻), tridecachlorohydrocyclohexasilane dianiorn salt (e.g. [Ph₄P⁺]₂[Si₆HCl₁₃]²⁻), tetradecachlorocyclohexasilane dianion salt (e.g., [Ph₄P⁺]₂[Si₆Cl₁₄]²⁻) is prepared.

When trichlorosilane is used as the halosilane compound and the ammonium salt is used, the salt of the polyhalosilane compound (preferably the cyclic halosilane compound) dianion and an ammonium ion such as dodecachlorodihydrocyclohexasilane dianion salt (e.g., [Et₄N⁺]₂[Si₆H₂Cl₁₂]²⁻), tridecachlorohydrocyclohexasilane dianion salt (e.g., [Et₄N⁺]₂[Si₆HCl₁₃]²⁻) tetradecachlorocyclohexasilane dianion salt (e.g., [Et₄N⁺]₂[Si₆HCl₁₄]²⁻) is prepared.

The above cyclization coupling step may be carried out in the presence of a chelating ligand such as a polyether compound (preferably 1,2-dimethoxyethane), a polythioether compound, or a multidentate phosphine compound (preferably 1,2-bis(diphenylphosphino) ethane).

The above cyclization coupling step may be carried out in the presence of a basic compound. The above basic compound includes, for example, (mono-, di-, tri-, poly-)amine compound and the basic compound is preferably a monoamine compound. Specifically, for example, the basic compound is preferably triethylamine, tripropylamine, tributylamine, trioctylamine, triisobutylamine, triisopentylamine, diethylmethylamine, diisopropylethylamine, dimethylbutylamine, dimethyl-2-ethylhexylamine, diisopropyl-2-ethylhexylamine, and methyldioctylamine, and particularly preferably tributylamine. The basic compound may be used individually or in combination of two or more.

The salt of the polyhalosilane compound (preferably the cyclic halosilane compound) may be purified as necessary prior to the reaction with the aluminum halide compound. By refining the salt of the polyhalosilane compound (preferably the cyclic halosilane compound) to increase its purity, the formation of byproducts in the reaction with the aluminum halide compound can be suppressed. The salt of the polyhalosilane compound (preferably the cyclic halosilane compound) can be purified by using known purification methods such as solid-liquid separation, distillation (solvent distillation), crystallization, and extraction. The solid-liquid separation in this case is not particularly limited, and known solid-liquid separations such as filtration, precipitation separation, centrifugation, and decantation can be used.

The salt of the polyhalosilane compound (C2) as the halosilane raw material (C0) may be obtained by contacting step (P4) of the halogenated monosilane compound (C4) with at least one selected from the phosphonium salt and the ammonium salt (R1). The contacting step (P4) may be carried out in the same manner as described above.

In an aspect of the present invention, the salt of the cyclic halosilane compound is obtained by contacting step (D) of the halogenated monosilane compound with at least one selected from the phosphonium salt and the ammonium salt.

### <Complex of Polyhalosilane Compound (Preferably Cyclic Halosilane Compound) (C3)>

In the present invention, the complex of the cyclic halosilane compound contains a ring structure containing one or more S1 atoms and one or more S1-halogen bonds, and may include at least one coordination compound, and the ring structure may have a substituent. The number of Si atoms in one molecule in the complex of the polyhalosilane compound (preferably the cyclic halosilane compound) of the present invention is preferably 3 or more, more preferably 5 or more, preferably 14 or less, and more preferably 7 or less. The complex of the polyhalosilane compound (preferably the cyclic halosilane compound) of the present invention contain preferably a silicon monoatomic ring.

The complex of the polyhalosilane compound (preferably the cyclic halosilane compound) of the present invention is preferably a complex of a polyhalosilane compound (preferably a neutral complex of the cyclic halosilane compound) containing at least one of a coordination compound selected from the group consisting of the following (i) and (ii).
(i) compound represented with XRₕ (when X is P, P═O or N, h=3 and each R represents a substituted or unsubstituted alkyl group or aryl group and Rs are the same or different; when X is S, S═O or O, h=2 and each R represents the same group as described above and Rs are the same or different; and the number of an amino group in XRₕ is 0 or 1), and
(ii) substituted or unsubstituted heterocyclic compound containing N, O, S or P with an unshared electron pair in the ring

The complex of the polyhalosilane compound (preferably the cyclic halosilane compound) of the present invention is preferably the complex of the polyhalosilane compound represented by the following general formula (9) (preferably the neutral complex of the cyclic halosilane).

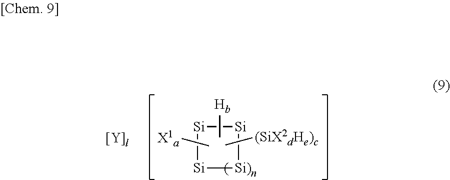

In the above general formula (9), X¹, X², a, b, c, d, e, and their preferred forms are the same as in the above general formula (6), and Y is at least one coordination compound selected from the group consisting of a compound represented by the (i) XRₕ (h=3 when X is P, P═O, or N, R represents a substituted or unsubstituted alkyl group or aryl group, identically or differently, h=2 when X is S, S=0, 0, and R represents the same group as above, either identically or differently. The number of an amino group in XRₕ is 0 or 1), and (ii) a substituted or unsubstituted heterocyclic compound containing N, O, S or P with an unshared electron pair in the ring, and 1 is 1 or 2.

Specific examples of the (i) compound include a compound in which X is P, P═O, or N, such as triphenylphosphine (PPh₃), triphenylphosphine oxide (Ph₃P═O), tris(4-methoxyphenyl) phosphine (P(MeOPh)₃) and triphenylamine; and a compound in which X is S═O, such as dimethyl sulfoxide.

The heterocyclic compound in the above (ii) is required to have an unshared electron pair in the ring, and the unshared electron pair coordinates to a cyclic silane to form a neutral complex of the polyhalosilane compound complex (preferably the cyclic halosilane neutral complex). Examples of such a heterocyclic compound include at least one substituted or unsubstituted heterocyclic compound containing N, O, S or P with an unshared electron pair in the ring. The substituents that may be possessed by the heterocyclic compound are the same as the substituents that may be possessed by R as an alkyl group or an aryl group in the case where X is P or P═O. Examples of the heterocyclic compound include pyridines, imidazoles, pyrazoles, oxazoles, thiazoles, imidazolines, pyrazines, thiophenes and furans, and specific examples include N,N-dimethyl-4-aminopyridine, tetrahydrothiophene and tetrahydrofuran.

As preferred examples of complexes of the polyhalosilane compound (preferably the cyclic halosilane compound) of the present invention, [PPh₃]₂[Si₆Cl₁₂], [Ph₃P═O]₂[Si₆Cl₁₂], [P(CH₃OPh)₃]₂[Si₆Cl₁₂], [N,N-dimethyl-4-aminopyridine]₂[SiCl₁₂] and the like are exemplified.

The complex of the polyhalosilane compound (C3) as the halosilane raw material (C0) may be obtained by contacting step (P5) of the halogenated monosilane compound (C4) with a coordination compound.

The coordination compound is preferably at least one selected from the group consisting of (i) and (ii) above.

The method for producing a hydrogenated polysilane compound of the present invention may include a step for cyclizing a halogenated monosilane compound in the presence of at least one coordination compound selected from (i) and (ii) above. The halogenated monosilane compound can be the above-mentioned compound.

The cyclizing step is preferably carried out in the presence of a tertiary amine. The tertiary amine includes, for example, triethylamine, tripropylamine, tributylamine, trioctylamine, triisobutylamine, triisopentylamine, diethylmethylamine, diisopropylethylamine (DIPEA), dimethylbutylamine, dimethyl-2-ethylhexylamine, diisopropyl-2-ethylhexylamine, and methyl dioctylamine. When using the tertiary amine, the tertiary amine may be used individually or in combination of two or more.

The amount of the coordination compound, the halogenated monosilane compound, and the tertiary amine used in the cyclization step may be determined as needed. The amount of the coordination compound is preferably 1 mol or more, more preferably 2 mol or more, preferably 50 mol or less, and more preferably 10 mol or less for 1 mole of the halogenated monosilane compound. The amount of the tertiary amine is preferably 0.5 to 4 mol, and particularly preferably the same mol per 1 mol of the halogenated monosilane compound.

The cyclization step can be carried out in an organic solvent if necessary. The organic solvent can be, for example, a halogenated hydrocarbon solvent such as chloroform, dichloromethane, 1,2-dichloroethane, an ether solvent such as diethyl ether, tetrahydrofuran, cyclopentyl methyl ether, diisopropyl ether, methyl tertiary butyl ether, other nonprotic polar solvent such as acetonitrile, and ethyl acetate. Among these, a chlorinated hydrocarbon solvent such as chloroform dichloromethane, and 1,2-dichloroethane is preferred, especially dichloromethane and 1,2-dichloroethane are particularly preferable. These organic solvents may be used individually or in combination of two or more. The amount of the organic solvent used is not particularly restricted, and the concentration of the halogenated monosilane compound be adjusted to be preferably 0.5 to 10 mol/L, more preferably 0.8 to 8 mol/L, and even preferably 1 to 5 mol/L.

The reaction temperature in the cyclization step can be set appropriately according to reactivity, and for example, is from 0 to 120° C. and preferably from 15 to 70° C.

The halosilane raw material (C0) is preferably a polyhalosilane compound (C1). It is more preferred that the polyhalosilane compound (C1) is a cyclic halosilane compound and the hydrogenated polysilane compound (CX) described below is a cyclic hydrogenated silane compound.

In an aspect of the present invention, at least one selected from a cyclic halosilane compound, a salt of the cyclic halosilane compound, and a complex of the cyclic halosilane compound is contacted with a reducing agent (also called step (A)).

In an aspect of the present invention, the salt of the above cyclic halosilane compound (also called a cyclic halosilane compound (D)) can be contacted and reacted with an aluminum halide compound to obtain a free cyclic halosilane compound (a non-complex cyclic halosilane compound) together with a residue (an aluminum complex). The non-complex cyclic halosilane compound has higher solvent solubility than a complexed cyclic halosilane compound. Therefore, when the obtained non-complexed cyclic halosilane compound is reduced by contacting it with a metal hydride, the reduction reaction of the cyclic halosilane compound can be carried out under high concentration, and the cyclic hydrogenated silane compound can be efficiently produced.

In the contacting step of the above salt of the cyclic halosilane compound with the aluminum halide compound, for example, a cyclic halosilane compound represented by the following formula (10) can be obtained from the salt of the cyclic halosilane compound represented by the above formula (6).

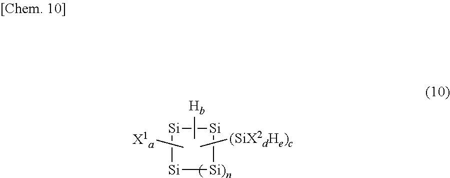

In the above formula (10), X¹, X², a to e, and n represent the same meaning as above.

In formula (10), n is preferably between 0 and 5, more preferably 1 or more, even preferably 2 or more, and preferably 4 or less, and more preferably 3 or less. n is particularly preferably 3, i.e. it is preferable that the formula (10) represents a 6-membered silicon monoatomic ring.

In formula (10), the halogen atoms of X and X² are a chlorine atom, a bromine atom, an iodine atom and a fluorine atom, preferably a chlorine atom and a bromine atom, and more preferably a chlorine atom. When X are multiple, the plurality of X¹ may be identical or different. When X² are multiple, the plurality of X² may be identical or different.

In formula (10), a, b and c represent integers from 0 to 2n+6 (where a+b+c=2n+6, a and c are not 0 simultaneously). It is preferred that a is an integer from 1 to 2n+6 and b and c are integers from 0 to n+5, it is more preferred that a is an integer from n+6 to 2n+6 and b and c are integers from 0 to n, and it is particularly preferred that a is 2n+6 and b and c are 0.

On the other hand, the cyclic halosilane compound obtained by the reaction of the above salt of the cyclic halosilane compound with the above Lewis acid compound may be purified as necessary to remove impurities. The above cyclic halosilane compound can be purified using known means such as solid-liquid separation, distillation (solvent distillation), crystallization, extraction.

### <Reducing Agent (R2)>

In the reducing step (P1) (also called step (A) and step 2), the reducing agent (R2) (also called reducing agent (B)) used in contact with the halosilane raw material (C0) is not particularly limited, and includes a neutral or ionic hydride compound, and the reducing agent (R2) is preferably a metal hydride (also called a metal hydride (E)).

The reducing agent (R2) is more preferably at least one selected from an aluminum hydride compound, a boron hydride compound, a silicon hydride compound, a tin hydride compound, and a transition metal hydride compound, and the reducing agent (R2) is even preferably an aluminum hydride compound, or a boron hydride compound. The aluminum hydride compound is specifically exemplified by lithium aluminum hydride (LiAlH₄; LAN), diisobutyl aluminum hydride (DIBAL), sodium bis(2-methoxyethoxy) aluminum hydride [“Red-Al (registered trademark of Sigma-Aldrich)], and the like. Examples of the boron hydride compound includes sodium boron hydride, lithium triethylborohydride, nickel boron hydride, and zinc boron hydride. Examples of the silicon hydride compound includes triethylsilane, triisopropylsilane, and the like. Examples of the tin hydride compound includes tributyltin hydride. The reducing agent (R2) may be used individually or in combination of two or more kinds.

The amount of the reducing agent (R2) used in the reducing step (P1) may be set appropriately, for example, the equivalent amount of hydride of the hydride compound to one silicon-halogen bond of the halosilane raw material (C0) (preferably the cyclic halosilane compound) is preferably 0.5 equivalents or more, more preferably 0.8 equivalents or more, even preferably 0.9 equivalents or more, and preferably 15 equivalents or less, more preferably 5 equivalents or less, and even preferably 2 equivalents or less. In one embodiment, the amount of the reducing agent (R2) is more preferably 1.0 to 50 equivalents, even preferably 1.0 to 30 equivalents, particularly preferably 1.0 to 15 equivalents, and most preferably 1.0 to 2 equivalents. If too much of the above reducing agent (R2) is used, post-treatment tends to be time consuming and productivity is reduced. On the other hand, if too little reducing agent (R2) is used, halogens remain unreduced and the yield tends to decrease.

In an aspect of the present invention, the reducing agent (R2) and/or the resulting material of the reducing agent (R2) is preferably solid at a temperature of 30° C., more preferably an aluminum hydride compound, and even preferably lithium aluminum hydride.

In an aspect of the present invention, the reducing agent (R2) and/or the resulting material of the reducing agent (R2) is preferably a liquid at a temperature of 30° C. The reducing agent (R2) is more preferably either an aluminum hydride compound or a boron hydride compound, even preferably an aluminum hydride compound having Al—R¹ (R¹ is an alkyl group that may be branched) or Al—OR² (R² is an alkyl group that may be branched).

R¹ and R² include a linear alkyl group such as methyl, ethyl, butyl, propyl, hexyl, heptyl, octyl, octyl, nonyl, decyl; and a branched alkyl group such as isopropyl, isobutyl, t-butyl, s-butyl, and neopentyl, 2-ethylhexyl.

The carbon numbers of R¹ and R² are, for example, 1 to 10, preferably 1 to 8, more preferably 1 to 6, and even preferably 1 to 4.

The aluminum hydride compound may have more than one R¹ and R² each, and each of R¹ and R² may be the same or different.

In an aspect of the present invention, from the viewpoint of preventing solid residues from adhering to the tank walls and piping even if the reaction system is used for a long time, reducing pipe blockage and cleaning, and eliminating the need for solid-liquid separation, it is preferred that the reducing agent (R2) and the resulting material of the reducing agent (R2) are a liquid at a temperature of 30° C., it is more preferred that an aluminum hydride compound represented with Al—R1 and a resulting material of the aluminum hydride compound represented with Al—R1 are a liquid at a temperature of 30° C., it is even preferred that diisobutyl aluminum hydride compound and a resulting material of diisobutyl aluminum hydride compound are a liquid at a temperature of 30° C.

In an aspect of the present invention, the melting point of the reducing agent (R2) is preferably 30° C. or lower, more preferably 25° C. or lower, even preferably 20° C. or lower, even more preferably 15° C. or lower, and particularly preferably 10° C. or lower, preferably −150° C. or higher or −100° C. or higher.

The melting point of the resulting material of the reducing agent (R2) may be the same as the melting point of the reducing agent (R2). The melting point of the resulting material of the reducing agent (R2) is preferably 70° C. or lower, more preferably 65° C. or lower, even preferably 60° C. or lower, even more preferably 55° C. or lower, and preferably −110° C. or higher or −60° C. or higher.

The contact in the reducing step (P1) is preferably carried out in the presence of a solvent (S1) (hereinafter referred to as a solvent (F) or a reaction solvent (11)).

The solvent (S1) is preferably an organic solvent, more preferably including at least one selected from a hydrocarbon solvent and an ether solvent.

The solvent (S1) may contain an ether solvent, and the solvent (S1) may contain a hydrocarbon solvent. These solvents may be the same as those described above.

At least one of the solvent (S1) and the solvent (S2) may be an ether solvent.

The solvent (S1) is preferably a solvent for reducing agent (R2) and the solvent (S2) is preferably a solvent for the polyhalosilane compound (preferably cyclic halosilane compound (D)), and the solvent (S2) and the solvent (S1) may be present together during the reducing step.

The reducing step (P1) may be carried out in the presence of one or more solvents. In the present invention, a solvent is any solvent that dissolves any one or more of the reaction materials and/or any one or more of the reaction products. The reaction solvent (II) used in the reducing step is preferably purified by distillation or dehydration before the reaction in order to remove water and dissolved oxygen contained therein.

The amount of the solvent (S1) used may be such that the amount of reducing agent used is satisfied as described above, and is preferably 1 to 10000 parts by mass, more preferably 100 to 5000 parts by mass, and even preferably 400 to 2000 parts by mass per 100 parts by mass of the reducing agent.

In the reducing step (P1), a solvent may be used such that the amount of the halosilane raw material (C0) (preferably the cyclic halosilane compound) used is 0.01 mol or more and 5.0 mol or less per 1 L of the solvent.

As to the amount of the solvent used in the reducing step (P1), it is preferable that the total amount of the halosilane raw material (C0) (preferably the cyclic halosilane compound) and the like is preferably 0.01 mol or more, more preferably 0.05 mol or more, and even preferably 0.10 mol or more, preferably 5.0 mol or less, more preferably 3.0 mol or less, and even preferably 1.0 mol or less per 1 L of the solvent. When the reaction is carried out using the solvent in the above ranges, the efficiency of the reduction reaction tends to be improved.

In the reducing step (P1), the total concentration of the halosilane raw material (C0) (preferably the cyclic halosilane compound) and the hydrogenated polysilane compound (preferably the cyclic hydrogenated silane compound) in the reaction solution is preferably 0.01 mol/L. or more, more preferably 0.05 mol/L or more, even preferably 0.10 mol/L, or more, preferably 5.0 mol/L or less, more preferably 3.0 mol/L or less, and even preferably 1.0 mol/L or less. When the reaction is carried out within the above range, the efficiency of the reduction reaction tends to be improved.

The reaction temperature in the reducing step (P1) may be appropriately adjusted according to the reactivity, and preferably −60° C. or higher, more preferably −40° C. or higher, even preferably −20° C. or higher, and preferably 150° C. or lower, more preferably 100° C. or lower, even preferably 80° C. or lower, and particularly preferably 70° C. or lower. The reaction time can be appropriately adjusted according to the degree of progress of the reaction. For example, the reaction time is preferably 10 minutes or longer, more preferably 1 hour or longer, even preferably 2 hours or longer, preferably 72 hours or shorter, more preferably 48 hours or shorter, and even preferably 24 hours or shorter.

The reducing step (P1) is preferably carried out under an inert gas atmosphere such as nitrogen gas, argon gas.

In the reducing step (P1), it is preferred that the halosilane raw material (C0) (preferably the cyclic halosilane compound) is contacted with a reducing agent in the presence of a solvent. For example, the method for contacting a cyclic halosilane compound with a reducing agent in the presence of a solvent is as follows: (1) a method for dissolving or dispersing one of the halosilane raw material (C0) (preferably the cyclic halosilane compound) and the reducing agent in a solvent to make a solution or dispersion, and mixing it with the other (adding the other to the solution or dispersion or adding the solution or dispersion to the other), (2) a method for dissolving or dispersing both the halosilane raw material (C0) (preferably the cyclic halosilane compound) and the reducing agent in a solvent to make a solution or dispersion, and then mixing them with the other; (3) a method for adding the halosilane raw material (C0) (preferably the cyclic halosilane compound) and the reducing agent simultaneously or sequentially in a solvent. Among these, the above method (2) is particularly preferred.

In the reducing step (P1), one or both of the halosilane raw material (CC) (preferably the cyclic halosilane compound) and the reducing agent may be added to the reaction system in a batch. It is preferable that one or both of the halosilane raw material (C0) (preferably the cyclic halosilane compound) and the reducing agent is sequentially added to the reaction system. Sequential addition may be divided addition and is preferably continuous addition.

The reducing step (P1) may be a reaction in a batch reactor or a continuous reactor using a continuous layer reactor such as a CSTR or a tube reactor such as a micro reactor or a flow reactor.

The molar concentration of the halosilane raw material (C0) (preferably the cyclic halosilane compound, also referred to as a cyclic halosilane compound (D)) in the reducing step (P1) (also referred to as a molar concentration of cyclic halosilane compound (D) in step 2) is preferably 0,150 mol/L or more, more preferably 0.155 mol/L or more, even preferably 0.160 mol/L or more, even more preferably 0.165 mol/L or more, preferably 1.000 mol/L or less, more preferably 0.900 mol/L or less, and even preferably 0.850 mol/L or less, from the viewpoint of increasing yield and purity of the hydrogenated polysilane compound (preferably the cyclic hydrogenated silane compound).

Here, the halosilane raw material (C0) (preferably the cyclic halosilane compound) or a solution or dispersion thereof and the reducing agent (preferably the metal hydride) or solution or dispersion thereof may be added in a batch or continuously or stepwise. In that case, the molar concentration of the cyclic halosilane compound in the step 2 may be the molar concentration of the total amount of cyclic halosilane compound used in the step 2 relative to the total amount of the solvent used in the step 2.

The ratio of the molar concentration of the halosilane raw material (C0) (preferably the cyclic halosilane compound) in the reducing step (P1) to the number of a silicon atom in the halosilane raw material (C0) (preferably the cyclic halosilane compound) in the reducing step (P1) is preferably 0.90 mol/L or more, more preferably 0.95 mol/L or more, even preferably 1.00 mol/L or more, preferably 5.00 mol/L or less, more preferably 4.90 mol/L or less, and even preferably 4.80 mol/L or less.

The ratio may be a value that simultaneously satisfies the above molar concentration of the halosilane raw material (C0) (preferably the cyclic halosilane compound), and is applicable in any case of batch addition or sequential addition or divided addition.

The reducing step (P1) may be carried out in a batch reactor, or the reducing (P1) may be carried out in a continuous reactor.

The reaction solution (also referred to as a reduction reaction solution) of the reducing step (P1) contains the hydrogenated polysilane compound (CX) and the reducing agent (R2) and/or the resulting material of the reducing agent (R2), and preferably a cyclic hydrogenated silane compound and an aluminum complex.

The resulting material of the reducing step (P1) includes a resulting material of the reducing agent (R2) and the resulting material can include an aluminum complex.

The aluminum complex is preferably a complex of aluminum or aluminum halide and an ether solvent.

The reducing agent ((2) and/or the resulting material of the reducing agent (R2) contained in the reaction solution of the reducing step (P1) is removed by one or more steps selected from the following (T1) to (T4).
(T1) separating step of a solid and a liquid
(T2) separating step of one liquid and another comprising a reaction solution, a concentrated solution of the reaction solution, or a washing solution of the reaction solution or the concentrated solution of the reaction solution
(T3) contacting step with an acid aqueous solution
(T4) distilling step of a hydrogenated polysilane compound (CX)

### <(T1) Separating Step of Solid and Liquid>

The (T1) separating step of a solid and a liquid is preferably filtering step.

The filtering step may be filtration carried out at normal pressure and temperature, or filtration with varying pressure or temperature.

The filtration can be spontaneous filtration, reduced pressure filtration, pressurized filtration, centrifugal filtration, thermal time filtration, etc.

Filter paper, glass fiber filters, membrane filters, filter plates and the like can be used in filtration.

In an aspect of the present invention, it is preferable to perform the filtering step on the upper or lower layer in the reaction solution, a concentrated solution of the reaction solution, or a washing solution of the reaction solution or a concentrated solution of the reaction solution, and it is more preferable to perform the filtering step on the lower layer in the reaction solution, a concentrated solution of the reaction solution, or a washing solution of the reaction solution or a concentrated solution of the reaction solution.

In an aspect of the present invention, the filtering step alone may not be sufficient to remove aluminum complexes.

### <(T2) Separating Step of One Liquid and Another Comprising Reaction Solution, Concentrated Solution of Reaction Solution, or Washing Solution of Reaction Solution or Concentrated Solution of Reaction Solution>

The separating step of one liquid and another is an operation to extract or take out the layer containing the desired substance from the multiple layers generated. The separating step may be any of a liquid separation of the reaction solution containing layers separated in the reaction, a liquid separation of the washing solution containing layers separated with the acid aqueous solution, water, or a solvent, a liquid separation of a solution containing layers separated with concentration, dilution, or change of temperatures and pressures, or a liquid separation of a solution containing layers separated with the addition of an additive for promoting a layer separation. The separating step is not limited, and can be carried out by any known method, such as liquid separation by decantation, liquid separation by funneling, etc.

The reaction solution is a composition containing the hydrogenated polysilane compound (preferably the cyclic hydrogenated silane compound, also called cyclic hydrogenated silane compound (G)) and the aluminum complex (also called aluminum complex (H)), the concentrated solution is a solution in which the solvent in the composition is volatilized by reducing pressure or heating the composition, and the washing solution is a solution after contacting the reaction solution or the concentrated solution with an acid aqueous solution, as described below.

In an aspect of the present invention, the reaction solution generated in the reducing step (P1) may be collected by concentration. When concentrating the reaction solution, the reaction solution may be concentrated to a volume of preferably 80% or more, more preferably 90% or more, and even preferably 95% or more of the original volume, and then the upper layer may be recovered by liquid separation.

The reaction solution may be separated into multiple layers by concentration.

The multiple layers include, for example, (i) an upper layer and a lower layer, (ii) an upper layer, an intermediate layer, and a lower layer.

Concentration may be an operation to volatilize the solvent contained in the reaction solution by changing the temperature, pressure, etc. For example, the concentration includes decompression treatment, heating treatment and the like.

The separation is an operation to extract or take out a layer containing a desired substance from multiple layers, and includes liquid fractionation by decantation, liquid fractionation by funneling, and the like.

When the reaction solution is subjected to liquid separation, the upper layer preferably contains a hydrogenated polysilane compound (preferably a cyclic hydrogenated silane compound), and the lower layer preferably contains an aluminum complex. The lower layer may be, for example, concentrated under reduced pressure and subjected to filtration to remove the aluminum complex, and the lower layer without the aluminum complex may be used in the next step (preferably distilling step) together with the upper layer.

<(T3) Contacting Step with Acid Aqueous Solution>

The (T3) contacting step with an acid aqueous solution is preferably a (T3X) contacting step (also called step (B)) in which the reaction solution (also called reduction reaction solution obtained in the step (A)) of the reducing step (P1) is contacted with an acid aqueous solution. The washing with an acid aqueous solution can be any operation in which the reaction solution or concentrated solution thereof is brought into contact with an acid aqueous solution.

In the case of washing with an acid aqueous solution, contact between the reaction solution containing the hydrogenated polysilane compound (preferably a cyclic hydrogenated silane compound) or a concentrated solution thereof and the acid aqueous solution is preferably dropping of one or both of the reaction solution containing the hydrogenated polysilane compound (preferably the cyclic hydrogenated silane compound) or a concentrated solution thereof and the acid aqueous solution. By dropping of one or both of the reaction solution containing the hydrogenated polysilane compound (preferably the cyclic hydrogenated silane compound) or a concentrated solution thereof and the acid aqueous solution, the reducing agent (preferably a metal hydride) can be deactivated more gently than with water washing, and the heat generated can be controlled by the dropping rate and other factors. If water (neutral) is used instead of an acid aqueous solution, the reaction with the reducing agent (metal hydride) may cause the aqueous solution to become basic and decompose the hydrogenated polysilane compound, so that it is preferable that a reaction solution or a concentrated solution of the reaction solution is washed with an acid aqueous solution.

There are three preferred embodiments in which one or both of the reaction solution containing the hydrogenated polysilane compound (preferably the cyclic hydrogenated silane compound) or the concentrated solution thereof and the acid aqueous solution are dropped into a reactor: embodiment (A) in which a reaction solution containing a hydrogenated polysilane compound (preferably a cyclic hydrogenated silane compound) or a concentrated solution thereof is prepared in the reactor, and the acid aqueous solution is added dropwise thereto, embodiment (B) in which the acid aqueous solution is prepared in the reactor, and a reaction solution containing a hydrogenated polysilane compound (preferably a cyclic hydrogenated silane compound) or a concentrated solution thereof is added to the acid aqueous solution, embodiment (C) in which a reaction solution containing a hydrogenated polysilane compound (preferably a cyclic hydrogenated silane compound) or a concentrated solution thereof and an acid aqueous solution are dropped into the reactor simultaneously or sequentially. Among these, the above embodiment (B) is preferred, i.e., it is preferable that a reaction solution containing a hydrogenated polysilane compound (preferably a cyclic hydrogenated silane compound) or a concentrated solution thereof is dropwise added to an acid aqueous solution.

In an aspect of the present invention, prior to contact with the acid aqueous solution, the reaction solution or a concentrated solution thereof may be subjected to the separating step, and the upper and lower layer may be separated from the reaction solution or the concentrated solution thereof.

The concentration of the acid substance in the acid aqueous solution in the (T3) contacting step with the acid aqueous solution is preferably 0.01% by mass or more, more preferably 0.1% by mass or more, even preferably 0.5% by mass or more, even more preferably 1% by mass or more, preferably 60% by mass or less, more preferably 50% by mass or less, even preferably 40% by mass or less, even more preferably 20% by mass or less, even furthermore 15% by mass or less, and particularly preferably 10% by mass or less. In the above cases, adherence of components derived from the reducing agent to the production facility tends to be more suppressed.

The amount of the acid aqueous solution used is preferably 1 to 10000 parts by mass, more preferably 10 to 5000 parts by mass, and even more preferably 20 to 3000 parts by mass, per 100 parts by mass of the reducing agent (R2) and/or the resulting material of the reducing agent (R2). Alternatively, the lower limit of the amount of the acid aqueous solution used may be more than 100, 200, or 300 parts by mass.

The acid substance is particularly not limited and includes organic and inorganic acids. It is preferred that the acid aqueous solution in the contacting step (T3) with the above acid aqueous solution contains at least one selected from hydrochloric acid, sulfuric acid, nitric acid, and phosphoric acid. The preferred acid aqueous solution is an aqueous solution of sulfuric acid.

In the contacting step with an acid aqueous solution, it is preferable to sequentially add at least one of the reduction solution and the acid aqueous solution to the reactor when the reduction solution and the acid aqueous solution are contacted. By dropping one or both of the reduction solution and the acid aqueous solution in this manner, the residue of the reducing agent contained in the reduction solution tends to be decomposed while suppressing the formation of solid residue, and the heat generated and the generation of acid gas and hydrogen gas can also be controlled by the addition rate, leading to improved productivity.

In the contacting step with the acid aqueous solution, a preferred embodiment in which one or both of the reduction solution and the acid aqueous solution are added dropwise includes the above embodiments (A) to (C).

The acid aqueous solution used in the contacting step with an acid aqueous solution may be degassed beforehand in order to remove dissolved oxygen. Degassing may be carried out by bubbling inert gas such as nitrogen or argon into the acid aqueous solution, by repeating several times the process of depressurization and replacement by inert gas such as nitrogen or argon, by boiling under normal or reduced pressure, by irradiating with ultrasonic waves, or by a combination of two or more of the above.

It is preferred that the reactor used in the contacting step with an acid aqueous solution is equipped with stirring means. The stirring means can be dynamic stirring means such as stirring blades or static stirring means such as a static mixer.

In the contacting step with an acid aqueous solution, the reaction temperature may be adjusted accordingly, and the reaction temperature is preferably −80° C. or higher, more preferably −50° C. or higher, even preferably −30° C. or higher, and preferably 200° C. or lower, more preferably 150° C. or lower, and even preferably 100° C. or lower.

In the contacting step with acid aqueous solution, the mixture of the reduction solution and the acid aqueous solution may be separated into an aqueous phase and an organic phase (also called oil layer), and the solution containing the hydrogenated polysilane compound (preferably the cyclic hydrogenated silane compound) may be extracted by fractionating the organic phase. For complete removal of solids, the separated organic layer may be further contacted with an aqueous acid solution or water and separated again into an aqueous layer and an organic layer.

The extracted organic phase may also be further dehydrated. The dehydration process may use chemical desiccants of inorganic salts such as sodium sulfate or magnesium sulfate, or physical desiccants such as alumina silicates (zeolites) such as molecular sieves.

In an aspect, it is preferred that the contacting step (T3X) of the reaction solution with the acid aqueous solution is carried out after the reducing step (P1) without separating step of a solid and a liquid.

In the above case, adherence of components derived from the reducing agent to the production facility tends to be more suppressed. In the present invention, “contact of the reduction solution obtained in the reducing step (P1) with an acid aqueous solution” means bringing the reduction solution obtained in the reducing step (P1) into contact with an acid aqueous solution without substantially passing through the solid-liquid separation. Substantially without solid-liquid separation means that, for example, 10% by mass or more, preferably 5% by mass or more of the solid content is not separated from the reduction solution obtained in the reducing step (P1). It is more preferable that the contacting step with the acid aqueous solution is carried out following the reducing step (P1).

It is even preferred that the reduction solution is contacted with the acid aqueous solution without undergoing a concentration step in the contacting step with the acid aqueous solution. The solvent distillation may be carried out prior to contact with the acid aqueous solution, and it is preferred that concentration is carried out to a solid concentration of 30% by mass or less because excessive concentration may cause solidification of precipitated solids on the top of the concentration vessel, cooler, etc.

When both the reducing step (P1) and the contacting step (T3) of the reduction solution with the acid aqueous solution are carried out in a batch reactor, it is preferable to perform the reducing step (P1) and the contacting step (T3) of the reduction solution with the acid aqueous solution in the same reactor (reaction vessel). When both or either of the reducing step (P1) and the contacting step (T3) of the reduction solution with the acid aqueous solution are carried out in a continuous reactor, it is preferable to perform then in a micro reactor or a flow reactor.

It is preferred that the contacting step (T3) of the (T3X) reaction solution and the acid aqueous solution is carried out without both the separation and concentration of the reaction solution after the reducing step (P1).

The reduction solution obtained in the reducing step (P1) preferably contains a hydrogenated polysilane compound (preferably a cyclic hydrogenated silane compound) and an aluminum complex (also called aluminum complex (H)), the aluminum complex is more preferably a complex of aluminum or aluminum halide and an ether solvent. In the case of the above combination, the adhesion of solids tends to be more suppressed.

The aluminum complex is preferably a salt of an aluminum halide compound formed by contact between the aluminum halide compound and the solvent (S1) (preferably an ether solvent), and the aluminum complex contains a salt of the aluminum halide compound as the main component in an amount of preferably 50% by mass or more (preferably 60% by mass or more, more preferably 70% by mass or more, even preferably 80% by mass or more, and even more preferably 90% by mass or more).

### (T4) Distilling Step of Hydrogenated Polysilane Compound (CX)>

In this process, a mixture containing a hydrogenated polysilane compound and a reducing agent and/or a resulting material of the reducing agent is distilled to extract the hydrogenated polysilane compound.

An aspect of the present invention contains distilling step (C) of a cyclic hydrogenated silane compound (also referred to as cyclic hydrogenated silane compound (G)).

The distillation are not limited, and examples include monodistillation, precision distillation, molecular distillation, thin-film evaporation flash distillation, and combinations thereof.

The distillation may be either or both of atmospheric distillation and distillation under reduced pressure, and atmospheric distillation or distillation under reduced pressure is preferred, and distillation under reduced pressure is more preferred.

When the distillation is carried out under reduced pressure, for example, the pressure is preferably 5 to 400 Pa, more preferably 10 to 350 Pa, and even preferably 10 to 300 Pa. The temperature is preferably 20 to 80° C., and more preferably 30 to 65° C.

The distillation under reduced pressure is not limited particularly, and may be carried out in a known distillation column or under light-shielding conditions. The distillation may be carried out more than once.

The distillation may be batch distillation or continuous distillation. The above distillation is preferably carried out by dividing the fraction into multiple fractions, and only the appropriate fraction may be selected among the fractions obtained.

Optionally, a purification other than the distillation, such as a crystallization process, may be included.

Among them, it is preferred to further include distilling step of the cyclic hydrogenated silane compound after one or more steps of the (T1) to (T3) (also referred to as the separating step of aluminum complex) is carried out.

The aluminum complex is separated to distill the hydrogenated polysilane compound (preferably the cyclic hydrogenated silane compound), so that the hydrogenated polysilane compound (preferably the cyclic hydrogenated silane compound) with a reduced amount of aluminum can be obtained at high purity.

The solution containing the purified hydrogenated polysilane compound (preferably the cyclic hydrogenated silane compound) is further purified by distillation, and the solution containing the hydrogenated polysilane compound (preferably the cyclic hydrogenated silane compound) is concentrated if necessary and then the highly concentrated hydrogenated polysilane compound (preferably the cyclic hydrogenated silane compound, more preferably cyclohexasilane) may be distilled. This distillation is preferably distillation under reduced pressure. The distillation tinder reduced pressure is not limited particularly, and may be carried out in a known distillation column or under light-shielding conditions. The above distillation is preferably carried out by dividing the fraction into several fractions, and only the appropriate fraction may be selected among the fractions obtained.

In particular, the distillation (in particular, distillation under reduced pressure) may be carried out two times or more. For example, a solution containing a hydrogenated polysilane compound (preferably a cyclic hydrogenated silane compound) is distilled under reduced pressure to recover a fraction (first distillation) with an appropriate amount of the hydrogenated polysilane compound (preferably the cyclic hydrogenated silane compound) (in particular cyclohexasilane), this recovered fraction is again distilled under reduced pressure to recover a fraction (second distillation) with an appropriate amount of the hydrogenated polysilane compound (preferably cyclic hydrogenated silane compound) (especially cyclohexasilane), and the second distillation may be repeated as necessary.

In the present invention, any of the above (T1) to (T4) may be used, or two or more of the above (T1) to (T4) may be used.

Among others, the contacting step of the above (T3X) reaction solution with the acid aqueous solution and the (T4) distilling step of the hydrogenated polysilane compound (CX) may be carried out.

It is preferred that the removing step of the reducing agent (R2) and/or the resulting material of the reducing agent (R2) is at least two or more selected from the following (T1) to (T3): (T1) separating step of a solid and a liquid, (T2) separating step of one liquid and another comprising the reaction solution, a concentrated solution of the reaction solution or a washing solution of the reaction solution, a concentrated solution of the reaction solution, and (T3) contacting step with an acid aqueous solution.

It is more preferred that the removing step of the reducing agent (R2) and/or the resulting material of the reducing agent (R2) includes two of the (T1) separating step of a solid and a liquid and the (T2) separating step of one liquid and another comprising the reaction solution, a concentrated solution of the reaction solution or a washing solution of the reaction solution, a concentrated solution of the reaction solution, or the (12) separating step of one liquid and another comprising the reaction solution, a concentrated solution of the reaction solution or a washing solution of the reaction solution, a concentrated solution of the reaction solution, and the (T3) the contacting step with an acid aqueous solution.

An aspect of the present invention (a method for producing cyclic hydrogenated silane compound) includes: step 1 in which a salt of a cyclic halosilane compound (A) is contacted with an aluminum halide compound (B) in a solvent (C) to produce a cyclic halosilane compound (D); step 2 in which the cyclic halosilane compound (D) is contacted with a metal hydride (E) in a solvent (F) to obtain a composition containing a cyclic hydrogenated silane compound (G) and an aluminum complex (H); and step 3 in which the aluminum complex (H) is separated. The step 3 of separating the aluminum complex (H) includes at least two or more of (a) filtering step, (b) separating step of one liquid and another comprising the reaction solution, a concentrated solution of the reaction solution or a washing solution of the reaction solution, a concentrated solution of the reaction solution, and (c) washing step with an acid aqueous solution.

The present invention has a feature that the aluminum complex is separated with at least two or more of filtering step, separating step of one liquid and another comprising the reaction solution, a concentrated solution of the reaction solution or a washing solution of the reaction solution or a concentrated solution of the reaction solution, and washing step with an acid aqueous solution (and preferably with distillation). The combination of these makes it possible to safely and easily handle the aluminum complexes formed by the reaction of the salt of the cyclic halosilane compound and the aluminum halide compound, and to obtain a cyclic hydrogenated silane compound with a reduced amount of aluminum at high purity.

In an aspect of the present invention, it is preferred that the separating of the aluminum complex (H) is (a) separating step of one liquid and another comprising the reaction solution, a concentrated solution of the reaction solution, or a washing solution of the reaction solution or a concentrated solution of the reaction solution and (b) filtering step, or (a) separating step of one liquid and another comprising the reaction solution, a concentrated solution of the reaction solution, or a washing solution of the reaction solution or a concentrated solution of the reaction solution and (c) contacting step with an acid aqueous solution.

It is more preferred that the separating of the aluminum complex (H) is (a) separating step of the upper and lower layers formed by the reaction solution, a concentrated solution of the reaction solution, or a washing solution of the reaction solution or a concentrated solution of the reaction solution, and (b) filtering step of the resulting lower layer, or (c) contacting step of the reaction solution or a concentrated solution of the reaction solution with an acid aqueous solution, and (a) separating step of the upper and lower layer formed by the washed washing solution.

The lower layer obtained in the liquid separation may be subjected to filtering step, and the filtered lower layer may be combined with the upper layer.

After these steps, it is even preferred to further (T4) distill the hydrogenated polysilane compound (CX).

In an aspect of the present invention, the removing step of the reducing agent (R2) and/or the resulting material of the reducing agent (R2) may be at least one of the (T3) contacting step of the reducing agent (R2) and/or the resulting material of the reducing agent (R2) with an acid aqueous solution, and/or the (T4) distilling step of the hydrogenated polysilane compound (CX).

Prior to the distilling step, the mixture obtained in the contact between the (T3X) reaction solution and the acid aqueous solution or the layer containing the hydrogenated polysilane compound (CX) may be further contacted with water, and the step may be repeated multiple times. By such a step, the acid derived from the acid aqueous solution contained in the mixture can be removed, and corrosion of the storage container and generation of acid gas can be prevented. Such a step may also remove metals contained in trace amounts in the mixture (especially the hydrogenated polysilane compound).

The layer containing the hydrogenated polysilane compound (CX) is the organic layer (oil layer) among the water layer and the organic layer (oil layer) in the mixture obtained in the contact between the (T3X) reaction solution and the acid aqueous solution.

The organic layer can be obtained by the liquid separation of the mixture, volatilization of the solvent of the mixture and the like.

The amount of water used per wash is preferably 1 to 10000 parts by mass, more preferably 10 to 5000 parts by mass, and even preferably 20 to 3000 parts by mass per 100 parts by mass of the mixture obtained in the contacting step of the (T3X) reaction solution and the acid aqueous solution or the layer containing hydrogenated polysilane compound (CX).

In the hydrogenated polysilane compound obtained by the above, the reducing agent and the resulting material of the reducing agent are more removed.

### <Hydrogenated Polysilane Compound (CX) (Preferably Cyclic Hydrogenated Silane Compound)>

In the present invention, the hydrogenated polysilane compound (preferably the cyclic hydrogenated silane compound, also called a cyclic hydrogenated silane compound (G)) may be any compound having a ring structure containing one or more Si atoms and one or more Si—H bonds, and the ring structure may have a substituent. The number of Si atoms in one molecule in the hydrogenated polysilane compound (preferably the cyclic hydrogenated silane compound) of the present invention is preferably 3 or more, more preferably 5 or more, preferably 14 or less, and more preferably 7 or less. The hydrogenated polysilane compound of the present invention (preferably the cyclic hydrogenated silane compound) preferably contains a silicon monoatomic ring.

The hydrogenated polysilane compound (preferably the cyclic hydrogenated silane compound) of the present invention can be represented, for example, by the following general formula (11).

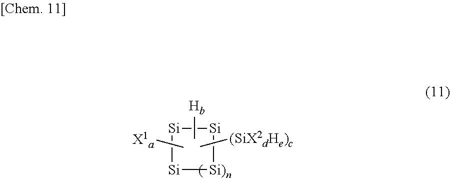

In the above general formula (11), X¹ and X² each independently represent a halogen atom, n represents the number from 0 to 5, b represents the number from 1 to 2n, a and c each represent the number from 0 to 2n−1 (provided that a+b+c=2n), d and e each represent the number from 0 to 3 (where d+e is 3).

In the above general formula (11), a is the number of a halogen atom directly bonded to Si atoms in the ring structure, b is the number of a hydrogen atom directly bonded to Si atoms in the ring structure, c is the number of —SiX²_{d}Hₑ group directly bonded to Si atoms in the ring structure.

For example, when n is 3, the ring structure contained in the hydrogenated polysilane compound (preferably the cyclic hydrogenated silane compound) of the present invention is a six-membered ring structure containing six Si atoms. d is the number of a halogen atom attached to the Si atoms in each —SiX²_{d}Hₑ group, and e is the number of a hydrogen atom bonded to the S1 atom in each —SiX²_{d}Hₑ group.

In the above general formula (11), n is preferably 2 or more and 4 or less. In the above general formula (11), b is preferably 10 or more and 14 or less. In the above general formula (11), c is preferably 1 or less and more preferably 0. In the above general formula (11), e is preferably 3.

In the above general formula (1), the halogen atoms of X¹ and X² include a chlorine atom, a bromine atom, an iodine atom and a fluorine atom, preferably a chlorine atom and a bromine atom, and more preferably a chlorine atom. When X¹ and/or X² are multiple, each of X¹ and/or X² may be identical or different.

The hydrogenated polysilane compound (preferably the cyclic hydrogenated silane compound, also called cyclic hydrogenated silane compound (G)) may have a monoatomic ring composed of a series of silicon atoms and may be a compound composed of silicon atoms and hydrogen atoms. The cyclic hydrogenated silane compound may have hydrogen atoms bonded to all substitution positions of the silicon atoms comprising the monoatomic ring, or may have an unsubstituted silyl group bonded to the silicon atoms comprising the monoatomic ring. However, from the viewpoint of storage stability, it is preferable that no silicon atoms other than those constituting the monoatomic ring be included. By reducing a cyclic halosilane compound rather than a salt of the cyclic halosilane compound, there is no silane gas generation derived from the counter cation of the salt, and the overall silane gas generation can be suppressed, so that cyclic hydrogenated silane compounds can be obtained in high yield and in a simple manner.

The cyclic hydrogenated silane compound obtained in the reducing step is preferably a compound represented by the following formula (12).

Si_{z}H_{2z} (12)

In the above formula (12), z represents the number of a silicon atom constituting the monoatomic ring. z is preferably 3 or more, more preferably 4 or more, even preferably 5 or more, and preferably 8 or less, more preferably 7 or less, and even preferably 6 or less.

The above cyclic hydrogenated silane compound is oxygen-prohibiting substances. Therefore, it is preferable to perform the above reducing step under an inert gas atmosphere such as nitrogen gas or argon gas.

The hydrogenated polysilane compound (preferably the cyclic hydrogenated silane compound) of the present invention includes cyclopentasilane, silylcyclopentasilane, cyclohexasilane, silylcyclohexasilane, cycloheptasilane, silylcyclobeptasilane, Si₅—H₉—Si₅H₉, Si₆H₁₁—Si₆H₁₁, Si₇H₁₃—Si₇H₁₃ and the like. The hydrogenated polysilane compound (preferably the cyclic hydrogenated silane compound) contains more preferably cyclopentasilane or cyclohexasilane, and is even preferably cyclohexasilane. The hydrogenated polysilane compound may be spontaneously combustible.

The content of cyclohexasilane is preferably 97% by mass or more, more preferably 975% by mass or more, and even preferably 98.0% by mass or more in 100% by mass of the cyclic hydrogenated silane compound, and may be as high as possible such as 100% by mass, and 99.9% by mass or less or 99.7% by mass or less.

The content may be based on an area percentage obtained from gas chromatography analysis.

A more preferred limitation of the present invention is that the polyhalosilane compound (C1) is a cyclic halosilane compound, the hydrogenated polysilane compound (CX) is a cyclic hydrogenated silane compound, and
as (T3) contacting step with an acid aqueous solution, the reaction solution of the reducing step (P1) is contacted with an acid aqueous solution (T3X).

According to such a method, it is possible to safely or efficiently produce a hydrogenated polysilane compound (such as a cyclic hydrogenated silane compound) because components derived from the reducing agent can be prevented from sticking to the production facility.

Even preferred limitation of the present invention is that the halosilane raw material (C0) is a cyclic halosilane compound, the hydrogenated polysilane compound (CX) is a cyclic hydrogenated silane compound,
the cyclic halosilane compound is formed by contacting step (P3) of a salt of the polyhalosilane compound (C21) with an aluminum halide compound in the presence of a solvent (S2),
the contact of the cyclic halosilane compound in the reducing step (P1) is carried out in the presence of the solvent (S1),
the reducing agent (R2) is a metal hydride (E), and the resulting material of the reducing agent (R2) contains an aluminum complex, and
the aluminum complex is removed by at least two or more of the following steps (T1) filtering step as separating step of a solid and a liquid, (T2) separating step of one liquid and another comprising the reaction solution, a concentrated solution of the reaction solution, or a washing solution of the reaction solution or a concentrated solution of the reaction solution, and (T3) contacting step with an acid aqueous solution.

According to such a method, the complexes (aluminum complexes, etc.) derived from the Lewis acid compound and the reducing agent generated by the reaction of a salt of a polyhalosilane compound (such as a salt of a cyclic halosilane compound) with a Lewis acid compound (such as an aluminum halide compound) or a reaction of a polyhalosilane compound (such as a cyclic halosilane compound or a salt of a cyclic halosilane compound) with a reducing agent can be handled safely and easily, and a hydrogenated polysilane compound (cyclic hydrogenated silane compound) with reduced amounts of metals (aluminum, etc.) derived from the Lewis acid compound and the reducing agent can be obtained with high purity.

A more even preferred limitation of the present invention is that the halosilane raw material (C0) is a polyhalosilane compound (C1),
the reducing agent (R2) and/or the resulting material of the reducing agent (R2) is a liquid at a temperature of 30° C.,
the contact in the reducing step (P1) is carried out in a batch reactor in the presence of the solvent (S1), and
the removing of the reducing agent (R2) and/or the resulting material of the reducing agent (R2) is at least one of (T3) contacting step of the reducing agent (R2) and/or the resulting material of the reducing agent (R2) with an acid aqueous solution and (T4) distilling step of the hydrogenated polysilane compound (CX).

That is, an aspect of the present invention (a method for producing a hydrogenated polysilane compound) is a method for producing, in a batch reactor, a hydrogenated polysilane compound (D) from a composition containing a polyhalosilane compound (A) containing a Si—Si bond and a Si—X bond (X represents a halogen atom) in the same molecule, a reducing agent (B) and a solvent (C), and the method comprises (i) contacting step of at least the polyhalosilane compound (A) and the reducing agent (B) to remove the reducing agent (B) and/or the resulting material of the reducing agent (B) by mixing with an acid aqueous solution, and/or (ii) the hydrogenated polysilane compound (D) is extracted by distillation, wherein the reducing agent (B) and/or the resulting material of the reducing agent (B) is a liquid at a temperature of 30° C.

In the present invention, when the reducing agent (B) and/or the resulting material of the reducing agent (B) is a liquid, it is possible to safely and stably prepare a hydrogenated polysilane compound by contact with acid aqueous solution and by extracting hydrogenated polysilane compound by distillation with little solid residue.

In the present invention, the resulting material of the reducing agent includes an aluminum-containing compound (e.g., an aluminum salt and complexes thereof).

The reaction field for producing the hydrogenated polysilane compounds is a batch reactor in which the feeding, reaction, and extraction of a compound is carried out in sequence.

The batch reactor is not limited as long as it can prepare the hydrogenated polysilane compound and the batch reactor is composed of metal, glass and preferably glass, stainless steel, titanium, copper, nickel, aluminum, and alloys thereof.

The batch reactor may have a tank structure so that feeding, reaction, and removal can be carried out in sequence, and may be a kettle, flask, beaker, or the like. The cross-section of the tank structure may be an ellipse, circle, semi-circle, triangle, polygon such as a square, or a combination thereof.

The amount of the polyhalosilane compound and the reducing agent may be adjusted appropriately so that these compounds react stoichiometrically. The amount (concentration) of the polyhalosilane compound, the amount (concentration) of the reducing agent, the solvent that can be used for the polyhalosilane compound and its usage, and the temperature of the batch reactor may be as described below.

The polyhalosilane compound (A) contains preferably a cyclic halosilane compound containing no salt or complex, more preferably a compound represented by formula (10), even preferably dodecabromnocyclohexasilane, dodecachlorocyclohexasilane, and more even preferably dodecachlorocyclohexasilane.

The polyhalosilane compound (A) may contain one or more of the above cyclic halosilane compound.

In the polyhalosilane compound (A), a salt of the cyclic halosilane compound or a complex of the cyclic halosilane compound may be used instead of the cyclic halosilane compound.

The polyhalosilane compound (A) may be the reaction solution of prepared polyhalosilane compound (A) as it is, the polyhalosilane compound once purified or the polyhalosilane compound dissolved in a given solvent.

The polyhalosilane compound (A) may be a composition together with a solvent or the like (also referred to as a first composition). The content of the polyhalosilane compound (A) is preferably 1 to 80% by mass, more preferably 2 to 60% by mass, even preferably 3 to 50% by mass, and particularly preferably 5 to 40% by mass in 100% w by mass of the first composition. The remainder of the first composition may be a solvent as described below.

The reducing agent (B) may be a composition together with a solvent or the like (also referred to as a second composition).

The content of the reducing agent (B) is preferably 5 to 80% by mass, more preferably 10 to 50% by mass, even preferably 15 to 40% by mass, and particularly preferably 20 to 30% by mass in 100% by mass of the second composition. The remainder of the second composition may be a solvent as described below.

The above polyhalosilane compound (preferably the salt of the cyclic halosilane, the free cyclic halosilane, the cyclic halosilane neutral complex, more preferably the free cyclic halosilane) is brought into contact with a reducing agent (reducing step) to prepare a hydrogenated polysilane compound.

The solvent (C) may be any organic solvent, such as a hydrocarbon solvent such as hexane and toluene; an ether solvent such as diethyl ether, tetrahydrofuran, cyclopentyl methyl ether, diisopropyl ether, and methyl tertiary butyl ether and the like. The organic solvent may be used individually or in combination of two or more. The solvent (C) contains preferably a hydrocarbon solvent. The organic solvent solution obtained when producing the polyhalosilane compound (the cyclic halosilane) may be used as the first composition, or the organic solvent solution containing the cyclic halosilane may be used as the first composition by removing the organic solvent from the organic solvent solution and adding a new organic solvent. The organic solvent used for the first and second compositions is preferably purified by distillation, dehydration, or other means prior to the reaction to remove water and dissolved oxygen contained therein.

The solvent used for the first composition is more preferably a hydrocarbon solvent, and the solvent used for the second composition is more preferably a hydrocarbon solvent.

The amount of the organic solvent is preferably adjusted so that the concentration of the polyhalosilane compound (the cyclic halosilane compound) is 0.01 to 1 mol/l, more preferably 0.02 to 0.7 mol/L, and even preferably 0.03 to 0.5 mol/L. By conducting the reaction in the above range, the content of impurities such as halogen elements in the composition containing the hydrogenated polysilane compound tends to be significantly reduced.

The concentration of the polyhalosilane compound (preferably the cyclic halosilane compound) in the first composition containing solvent is preferably 0.01 mol/L or more, more preferably 0.02 mol/L or more, even preferably 0.04 mol/L or more, and particularly preferably 0.05 mol/L or more. When the concentration of the polyhalosilane compound is too low, the amount of the solvent increases, which tends to lower productivity. On the other hand, the upper limit of the concentration of the polyhalosilane compound is preferably 1 mol/L or less, more preferably 0.8 mol/L or less, and even preferably 0.5 mol/L or less.

The lower limit of the temperature of the batch reactor is preferably −100° C. or higher, more preferably −70° C. or higher, even preferably −20° C. or higher, and even more preferably −0° C. or higher. The upper limit of the temperature of the batch reactor is preferably +150° C. or lower, more preferably +100° C. or lower, even preferably +50° C. or lower, even more preferably +30° C. or lower, and particularly preferably +20° C. or lower. Lower temperatures improve yields because decomposition and polymerization of intermediate products and target products can be suppressed. The reaction time may be determined according to the amount of the first and second compositions used and the degree of progress of the reaction, and is usually from 10 minutes to 30 hours, preferably from 20 minutes to 15 hours, and more preferably from 30 minutes to 5 hours, as the time to obtain the minimum amount of hydrogenated polysilane compound required.

The reaction time may not be in the above range, and the desired product may be prepared by further reaction over time to scale up the desired product.

The reactor is preferably equipped with a stirring device. When the reducing step of the polyhalosilane compound (A) and the contacting step with the acid aqueous solution are carried out in separate reactors, it is preferred that the reactor is equipped with a stirring device.

In the present invention, the hydrogenated polysilane compound (A) is produced from each of the following.

### Embodiment of Above (i)

The hydrogenated polysilane compound (D) is obtained by contacting at least the polyhalosilane compound (A) with the reducing agent (B) (preferably contacting the polyhalosilane compound (A) with the reducing agent (B) and the solvent (C)) and then removing the reducing agent (B) and/or the resulting material of the reducing agent (B) (preferably the resulting material of the polyhalosilane compound (A) with the reducing agent (B) in the presence of the solvent (C)) by mixing with an acid aqueous solution.

It is preferable that the hydrogenated polysilane compound (D) is obtained by mixing the reducing agent (B) and/or the resulting material of the reducing agent (B) with the acid aqueous solution, the mixed solution is subjected to separation of one liquid and another to remove the layer containing the reducing agent (B) and/or the resulting material of the reducing agent (B) to obtain a layer containing the hydrogenated polysilane compound (D).

The liquid separation can be an operation to extract or take out the layer containing the desired substance from the plurality of layers generated, and includes liquid fractionation by decantation operation, liquid fractionation by funnel and the like.

### Embodiment of Above (ii)

The hydrogenated polysilane compound (D) is obtained by contacting at least the polyhalosilane compound (A) with the reducing agent (B) (preferably contacting the polyhalosilane compound (A) with the reducing agent (B) and the solvent (C)) and then subjecting the mixture to distillation.

It is preferable that the mixture after contact is subjected to reduced pressure or heating to remove the solvent, and the composition from which the solvent has been removed is distilled (preferably distilled under reduced pressure) as described below.

### Embodiments of Above (i) and (ii)

The hydrogenated polysilane compound (D) is obtained by contacting at least the polyhalosilane compound (A) with the reducing agent (B) (preferably contacting the polyhalosilane compound (A), the reducing agent (B), and the solvent (C)), by removing the reducing agent (B) and/or the resulting material of the reducing agent (13) by mixing with an acid aqueous solution, and subjecting the resulting solution to distillation.

It is preferable that the hydrogenated polysilane compound (D) is obtained by mixing the reducing agent (B) and/or the resulting material of the reducing agent (B) with the acid aqueous solution, subjecting the mixture to separation, removing the layer containing the reducing agent (3) and/or the resulting material of the reducing agent (B) to obtain a layer containing the hydrogenated polysilane compound (D), and subjecting the layer to reduced pressure or heating to remove solvent and distilled as necessary.

In the embodiment including (ii) above, the filtration may not be carried out.

In the embodiment including the above (i), it is preferred that at least one of the reducing agent (B) and/or the resulting material of the reducing agent (B) and the acid aqueous solution is added dropwise when the reducing agent (B) and/or the resulting material of the reducing agent (B) is contacted with the acid aqueous solution. By adding dropwise one or both of the reducing agent (B) and/or the resulting material of the reducing agent (3) and the acid aqueous solution, the reducing agent (B) and/or the resulting material of the reducing agent (B) can be decomposed with almost no solid residue, and the heat generated can be suppressed by dropping rate, etc., resulting in the improvement of productivity.

In the embodiment containing the above (i), there are three preferred embodiments to add dropwise one or both of the reducing agent (B) and/or the resulting material of the reducing agent (B) and the acid aqueous solution. Embodiment (A) in which the reducing agent and/or the resulting material of the reducing agent is charged in the reactor and the acid aqueous solution is added dropwise thereto, Embodiment (B) in which the acid aqueous solution is charged in the reactor and the reducing agent and/or the resulting material of the reducing agent is added dropwise thereto. Embodiment (C) in which the reducing agent and/or the resulting material of the reducing agent and the acid aqueous solution are added dropwise into the reactor simultaneously or sequentially. Among these, the above Embodiment (B) is preferred, i.e., it is preferable that the reducing agent and/or the resulting material of the reducing agent are added dropwise to the acid aqueous solution.

The acid aqueous solution, its concentration, its amount, the reducing agent, its amount, and the solvent used for them may be as described above.

The reducing agent and/or the resulting material of the reducing agent are decomposed by mixing the reducing agent and/or the resulting material of the reducing agent with an acid aqueous solution. The mixture may be separated into an aqueous phase and an organic phase (also called oil layer), and the solution containing the hydrogenated polysilane compound may be extracted by fractionation of the organic phase.

### <Other Steps>

The method for producing the hydrogenated polysilane compound may include optional steps (hereinafter referred to as “other steps”) in addition to the above steps. Other steps include solid-liquid separation, liquid-liquid separation, extraction, washing, purification, concentration, dilution and the like.

### [Application of Cyclic Hydrogenated Silane Compound of Present Invention]

The cyclic hydrogenated silane compound obtained by the method for producing a cyclic hydrogenated silane compound of the present invention can be used as raw materials for chemical vapor deposition (CVD) and atomic layer deposition (ALD) to produce silicon-containing films. The CVD includes heat CVD, light CVD, plasma CVD, epitaxial CVD and the like without limitation.

The cyclic hydrogenated silane compound obtained by the method for producing a cyclic hydrogenated silane compound of the present invention can be photo-polymerized, so that silicon-containing films can be produced by a liquid phase process.

The purity of the cyclic hydrogenated silane compound obtained by the method of the present invention, i.e., the content of the cyclic hydrogenated silane compound in the composition containing the cyclic hydrogenated silane compound, is preferably 97.5% by mass or more, more preferably 98.0% by mass or more, and even preferably 98.5% by mass or more in 100% by mass of the cyclic hydrogenated silane compound, and it is desirable to have as much as 100% by mass, but the content of the cyclic hydrogenated silane compound may be 99.9% by mass or less or 99.7% by mass or less. Preferably, cyclohexasilane has the above range.

The concentration of the aluminum in the cyclic hydrogenated silane compound of the present invention or the composition containing the cyclic hydrogenated silane compound of the present invention is preferably 3000 ppm or less, more preferably 2500 ppm or less, even preferably 2000 ppm or less, even more preferably 1500 ppm or less, preferably 0.01 ppb or more.

The present application claims the benefit of priority based on Japanese Patent Application No. 2020-150656 filed on Sep. 8, 2020, Japanese Patent Application No. 2020-150657 filed on Sep. 8, 2020, and Japanese Patent Application No. 2021-059690 filed on Mar. 31, 2021. The entire contents of specifications of Japanese Patent Application No. 2020-150656 filed on Sep. 8, 2020, Japanese Patent Application No. 2020-150657 filed on Sep. 8, 2020, and Japanese Patent Application No. 2021-059690 filed on Mar. 31, 2021 are hereby incorporated by reference herein.

### EXAMPLES

The present invention is described in more detail in the following examples, but the present invention is not limited only to these examples. Unless otherwise specified, “part” means “part by mass” and “%” means “% by mass.

### Example 1-1

### 1. Production Example of Salt of Cyclic Halosilane Compound

To a 2 L four-necked flask equipped with a thermometer, a condenser, a dropping funnel, and a stirrer, nitrogen gas was charged to substitute an atmosphere within the flask, 123.5 g (0.59 mol) of tetraethylammonium bromide, 490.0 g (2.64 mol) of tributylamine, and 702.7 g of dichloromethane were added to the flask. Then, while stirring the solution in the flask, a solution consisting of 238.1 g (1.76 mol) of trichlorosilane and 117.2 g of dichloromethane was slowly added dropwise from a dropping funnel under a condition of a temperature of 25° C. After the drop was completed, the solution was stirred for 2 hours and then heated and stirred at 50° C. for 6 hours to carry out the cyclization coupling reaction After the reaction, the resulting solid was filtered and purified to obtain 102.7 g of a salt of a cyclic halosilane compound.

### 2. Production Example of Cyclic Halosilane Compound

Under a nitrogen atmosphere, 15.0 g of the white solid obtained in the above (1) and 4.6 g of powdered aluminum chloride (AlCl₃) were added in a 300-mL three-necked flask equipped with a stirrer, and 98.7 g of hexane was added thereto as solvent. The reaction was carried out under light-shielded conditions with stirring for 3 hours at room temperature, followed by filtration and concentration to obtain a hexane solution of cyclic halosilane compound (concentration: approx. 37% by mass).

### 3. Production Example of Cyclic Hydrogenated Silane Compound

To a 300-mL three-necked flask equipped with a dropping funnel and a stirring device, nitrogen gas was charged to substitute an atmosphere within the flask, 49 g of a hexane solution of the cyclic halosilane compound obtained in the above Example 1-1(2) was added thereto. While stirring the solution in the flask, 100 mL of a diethyl ether solution of lithium aluminum hydride (concentration: about 1.0 mol/L) was gradually added dropwise from the dropping funnel at 0° C., and then the reduction reaction was carried out by stirring at 25° C. for 1 hour. After the reaction, the resulting reaction solution was slowly added dropwise to a 10% aqueous sulfuric acid solution cooled to 0° C. After stirring at room temperature for 30 minutes, a clear colorless solution containing no solids in both the organic and aqueous layers was obtained. After allowing the solution to stand, the aqueous layer was removed by liquid separation and the organic layer was collected, and the organic layer was concentrated under reduced pressure to obtain 5.7 g of a crude product. At this time, no solids were observed adhering to the top of the concentrator or the cooler for solvent condensation.

The crude product was further purified by distillation under reduced pressure in a 100-mL glass distillation apparatus to obtain 2.8 g of colorless, transparent cyclohexasilane with an area purity of 98% by gas chromatography (GC). At this time, there were no solids adhering to the top of the distillation apparatus or the cooler for condensation after distillation.

In addition, as a result of analysis by gas chromatography (GC) and NMR, no aluminum complexes (complexes of aluminum chloride and diethyl ether solvent) were detected in the distillate obtained.

Furthermore, the amount of chlorine in the distillate was checked using an ion chromatography system (manufactured by DIONEX, “ICS-2000”) and detected to be 4 ppm.

### Comparative Example 1-1

### Comparative Production Example of Cyclic Hydrogenated Silane Compound

To a 500-mL three-necked flask equipped with a dropping funnel and a stirrer, nitrogen gas was charged to substitute an atmosphere within the flask, 136.1 g of a hexane solution of a cyclic halosilane compound obtained under the same conditions as in Example 1-1 (2) above was added. While stirring the solution in the flask, 314 mL of a diethyl ether solution of lithium aluminum hydride (concentration: about 1.0 mol/L) was gradually added dropwise from a dropping funnel at 0° C., followed by stirring at 25° C. for 1 hour to conduct the reduction reaction.

After the reaction, the obtained reaction solution containing the salt of solid residue was transferred to a filter and filtered under a nitrogen atmosphere to remove the salt of solid residue formed. The adhesion of the solid residues was found in the piping for transfer.

Next, the solvent was removed from the filtrate under reduced pressure and concentrated until the liquid volume was reduced to half, to obtain a concentrated solution consisting of an upper layer containing cyclohexasilane and a lower layer containing the solid residue. At this time, solid deposits were observed on the top of the concentrator and the cooler for solvent condensation.

Next, the concentrated solution was separated by filtration, and the resulting filtrate was further concentrated under reduced pressure and filtered to remove the lower layer containing the solid residue that was generated again to obtain 11.6 g of a crude product. Of this crude product, 8.4 g was further purified by distillation tinder reduced pressure in a 100-mL glass distillation apparatus to obtain 6.9 g of cyclohexasilane with an area purity of 98% by gas chromatography (GC).

At this time, solid deposits were observed on the top of the distillation apparatus and the cooler for condensation after distillation.

A white cloudiness was observed in a portion of the distillate (first distillate) during distillation, and by the results of gas chromatography (GC) and NMR analysis, the presence of an aluminum complex (a complex of aluminum chloride and diethyl ether solvent) was confirmed.

Furthermore, the amount of chlorine in the distillate was measured using an ion chromatography system (manufactured by DIONEX, “ICS-2000”) and was detected to be 2900 ppm.

From the above, the method of the present invention can efficiently produce the cyclic hydrogenated silane compound by preventing components derived from the reducing agent from sticking to the production facility and efficiently removing impurities derived from the reducing agent and other components.

### Measurement of Aluminum Content

### Analyzer: Multi-Type ICP Emission Spectrometer (ICPE-9000 Manufactured by Shiradzu Corporation)

Pretreatment was carried out according to the following procedure. First, 50 μL of cyclic hydrogenated silane compound was placed in a 100-mL PFA (polytetrafluoroethylene) container in a glove box under a nitrogen atmosphere, followed by 2500 μL of 12.5% TMAH (tetramethylammonium hydride solution). The lid was lightly closed and allowed to stand overnight to deactivate; after one night of standing, the mixture was diluted with 45 mL of 5% HNO₃ and allowed to stand another one night to complete the pretreatment.

The amount of Al in the pretreated cyclic hydrogenated silane compound was measured on the ICPE-9000 spectrometer manufactured by Shimadzu Corporation.

### Determination of Content of Cyclic Hydrogenated Silane Compound

The resulting cyclic hydrogenated silane compound was diluted to about 1% with cyclopentyl methyl ether in a glove box under a nitrogen atmosphere, and the content was measured by gas chromatography (GC). The content of the cyclic hydrogenated silane compound was calculated by the area percentage method.
(Gas chromatography (GC) analysis method)
Measuring method: GC FID method
Analyzer: GC2014 manufactured by Shimadzu Corporation
Column: DB-5MS 0.25 μm (Film)×0.25 mm (Diameter)×30 m (Length) (Agilent Technologies)
Vaporization chamber temperature: 250° C.
Detector temperature: 280° C.
Temperature elevating conditions: 50° C. for 5 minutes, elevation of temperature up to 250° C. at 20° C./minute, elevation of temperature up to 280° C. at 10° C./minute and hold for 10 minutes

### Example 2-1

### (1) Production Example of Cyclic Halosilane Compound Salt (A)

To a 2-L four-necked flask equipped with a thermometer, a condenser, a dropping funnel, and a stirrer, nitrogen gas was charged to substitute an atmosphere within the flask, 123.5 g (0.59 mol) of tetraethylammonium bromide, 490.0 g (2.64 mol) of tributylamine, and 702.7 g of dichloromethane were added to the flask. Then, while stirring the solution in the flask, a solution consisting of 238.1 g (1.76 mol) of trichlorosilane and 117.2 g of dichloromethane was slowly added dropwise from a dropping funnel under 25° C. conditions. After the drop was completed, the solution was stirred for 2 hours and then heated and stirred at 50° C. for 6 hours to carry out the cyclization coupling reaction. After the reaction, the resulting solid was filtered and purified to obtain 102.7 g of a salt of a cyclic halosilane compound (A).

### (2) Production Example of Cyclic Halosilane Compound (D)

Under a nitrogen atmosphere, 15.0 g of the white solid obtained in the above (1) and 4.6 g of powdered aluminum chloride (AlCl₃) as the aluminum halide compound (B) were added in a 300-mL three-necked flask equipped with a stirrer, and 98.7 g of hexane of the solvent (C) was added thereto. The reaction was carried out under light-shielded conditions with stirring for 3 hours at room temperature, followed by filtration and concentration to obtain a hexane solution of cyclic halosilane compound (D) (concentration: about 40% by mass).

### (3) Production Example of Cyclic Hydrogenated Silane Compound (G)

In a 100-mL three-necked flask equipped with a dropping funnel and a stirring device, 25 g of a hexane solution of cyclic halosilane compound (D) obtained in the above (2) was added. After replacing the flask with nitrogen gas, 76 mL of a diethyl ether solution of lithium aluminum hydride (concentration: about 1.0 mol/L) as the metal hydride (E) was gradually added dropwise from a dropping funnel under 0° C. conditions. The reduction reaction was then carried out by stirring at 25° C. for 1 hour. After the reaction, the reaction solution was separated into two layers by reduced pressure, and the lower layer contained aluminum complexes (H). The lower layer was separated by liquid separation and concentrated under reduced pressure until the hexane concentration was below 5%, and then filtered to remove the precipitated aluminum complex (H). The lower layer from which the aluminum complex (H) was removed was mixed with the upper layer and purified by distillation to yield 1.6 g of cyclohexasilane with an area purity of 99% by gas chromatography and an aluminum concentration of 1300 ppm as cyclic hydrogenated silane compound (G).

### Example 2-2

### (3) Production Example of Cyclic Hydrogenated Silane Compound (G)

In a 100-mL three-necked flask equipped with a dropping funnel and a stirrer, 25 g of a hexane solution of cyclic halosilane compound (D) obtained in Example 2-1 (2) above was added. After replacing the flask with nitrogen gas, 76 mL of a diethyl ether solution of lithium aluminum hydride (concentration: about 1.0 mol/L) as the metal hydride (E) was gradually added dropwise from a dropping funnel under 0° C. conditions. The reduction reaction was then carried out by stirring at 25° C. for 1 hour. After the reaction, the resulting reaction solution was separated into two layers, and the lower layer contained the aluminum complex (H). The liquid separated into two layers was slowly dropped into a 5% sulfuric acid solution, and after stirring for 10 minutes, the lower layer of the two separated layers was drained off, and the tipper layer was distilled and purified to obtain 1.6 g of cyclohexasilane with an area purity of 99% by gas chromatography and an aluminum concentration of 160 ppm as the cyclic hydrogenated silane compound (G).

### Example 3-1

After replacing nitrogen in a 300-mL three-necked flask equipped with a dropping funnel and a stirrer, 24.5 g of a 7% dodecachlorocyclohexasilane solution in hexane was added. While stirring the solution in the flask, 40 mL of 1.0 mol/L diisobutylaluminum hydride hexane solution (manufactured by WAKO) as reducing agent was gradually added dropwise from the dropping funnel at 0° C., and then the solution was stirred at room temperature for 3 hours. After the reaction, the reaction was deactivated by slowly dropping the reaction solution into 100 mL of degassed 10% aqueous sulfuric acid solution. The oil layer was removed by separation, dehydrated with magnesium sulfate, filtered, and analyzed by gas chromatography. The yield of cyclohexasilane was 78%. No solid precipitation was observed during the reaction or during deactivation. After the solvent was removed from the oil layer, cyclohexasilane was isolated by distillation under reduced pressure at 35′C and 200 Pa.

### Comparative Example 3-1

In a 100-mL three-necked flask equipped with a dropping funnel and a stirrer, 100.0 g of a 10% dodecachlorocyclohexasilane solution in hexane was added. After replacing the flask with nitrogen gas, 38 mL of a diethyl ether solution of lithium aluminum hydride (concentration: about 1.0 mol/L) was gradually added dropwise as a reducing agent from the dropping funnel at 0° C. while stirring the solution in the flask, and then the reduction reaction was conducted by stirring at 20° C. for 3 hours. After the reaction, a white solid was obtained. The reaction solution was filtered under a nitrogen atmosphere to remove the salts formed, and the filtrate was analyzed using gas chromatography to confirm that cyclohexasilane was formed (90% yield).

### Example 4

Under a nitrogen atmosphere, lithium aluminum hydride (12.0 g) and dibutyl ether (68 mL) were placed in a 500-mL three-necked flask equipped with a dropping funnel and a stirring device, and the flask was cooled to 0° C. while stirring. A heptane solution of 35% dodecachlorocyclohexasilane (169.0 g) was added to the dropping funnel and dropped slowly so that the temperature in the flask did not exceed 10° C., and then the mixture was stirred at room temperature. Deaerated 10% aqueous sulfuric acid solution (290 mL) was added to a I-L flask with nitrogen replacement, and the reaction was deactivated by dropping the reduction solution over 1.5 hours while cooling to 0° C. After removing the aqueous layer by separation, the resulting oil layer was washed twice with 50 m L of water. After removing the solvent from the oil layer, distillation under reduced pressure was carried out at 35° C. and 200 Pa, to obtain 10.1 g of cyclohexasilane with an area purity of 99% by gas chromatography and an aluminum concentration of 10 ppm or less (detection limit).

### INDUSTRIAL APPLICABILITY

According to the present invention, aluminum complexes formed from the reaction of salts of cyclic halosilane compounds with aluminum compounds or the reaction of cyclic halosilane compounds or salts of cyclic halosilane compounds with reducing agents can be handled safely and easily. The cyclic hydrogenated silane compound with reduced aluminum content and high purity are useful as silicon raw materials for solar cells and semiconductors. In the semiconductor field, the present invention can also be used to produce SiGe compounds and SiGe films by mixing or reacting with Ge compounds.

1. A method for producing a hydrogenated polysilane compound (CX) comprising
a reducing step (P1) in which at least one of a halosilane raw material (C0) selected from a polyhalosilane compound (C1) comprising a Si—Si bond and a Si—X bond (X represents a halogen atom) in the same molecule, a salt of the polyhalosilane compound (C2), and a complex of the polyhalosilane compound (C3) is contacted with a reducing agent (R2) to reduce the halosilane raw material (C0), and
a removing step in which a reaction solution of the reducing step (P1) is subjected to one or more steps selected from the following (T1) to (T4) to remove the reducing agent (R2) and/or a resulting material of the reducing agent (R2) contained in the reaction solution.
(T1) separating step of a solid and a liquid
(T2) separating step of one liquid and another comprising a reaction solution, a concentrated solution of the reaction solution, or a washing solution of the reaction solution or the concentrated solution of the reaction solution
(T3) contacting step with an acid aqueous solution
(T4) distilling step of the hydrogenated polysilane compound (CX)

2. The method according to claim 1, wherein the reducing step (P1) is carried out in a batch reactor.

3. The method according to claim 1, wherein the reducing step (P1) is carried out in a continuous reactor.

4. The method according to claim 1, wherein the reducing agent (R2) is a metal hydride (E).

5. The method according to claim 1, wherein the reducing agent (R2) is at least one selected from an aluminum hydride compound, a boron hydride compound, a silane hydride compound, a tin hydride compound, and a transition metal hydride compound.

6. The method according to claim 1, wherein the reducing agent (R2) and/or the resulting material of the reducing agent (R2) is a liquid at a temperature of 30° C.

7. The method according to claim 6, wherein the reducing agent (R2) is one of the aluminum hydride compound and the boron hydride compound.

8. The method according to claim 6, wherein the reducing agent (R2) is the aluminum hydride compound having Al—R¹ (R¹ is an alkyl group that may be branched) or Al—OR² (R² is an alkyl group that may be branched).

9. The method according to claim 1, wherein the contact in the reducing step (P1) is carried out in the presence of a solvent (S1).

10. The method according to claim 9, wherein the solvent (S1) comprises at least one selected from a hydrocarbon solvent and an ether solvent.

11. The method according to claim 9, wherein the solvent (S1) comprises the ether solvent.

12. The method according to claim 9, wherein the solvent (S1) comprises the hydrocarbon solvent.

13. The method according to claim 9, wherein the solvent is used in the reducing step (P1) such that the amount of the halosilane raw material (C0) is 0.01 mol or more and 5.0 mol or less per 1 L of the solvent.

14. The method according to claim 1, wherein a molar concentration of the halosilane raw material (C0) in the reducing step (P1) is 0.150 mol/L or higher.

15. The method according to claim 1, wherein a ratio of the molar concentration of the halosilane raw material (C0) to the number of a silicon atom in the halosilane raw material (C0) in the reducing step (P1) is 0.90 mol/L or higher.

16. The method according to claim 1, wherein the reaction solution of the reducing step (P1) comprises the hydrogenated polysilane compound (CX) and the reducing agent (B) and/or the resulting material of the reducing agent (B).

17. The method according to claim 16, wherein the reaction solution of the reducing step (P1) comprises the resulting material of the reducing agent (B), and the resulting material comprises an aluminum complex.

18. The method according to claim 17, wherein the aluminum complex is a complex of aluminum or aluminum halide and the ether solvent.

19. The method according to claim 1, wherein the (T3) contacting step with the acid aqueous solution is (T3X) contacting step of the reaction solution of the reducing step (P1) with the acid aqueous solution.

20. The method according to claim 19, wherein the (T3X) contacting step of the reaction solution with the acid aqueous solution is carried out after the reducing step (P1) without separating step of a solid and a liquid.

21. The method according to claim 20, wherein the (T3X) contacting step of the reaction solution with the acid aqueous solution is carried out without both the separation and concentration of the reaction solution after the reducing step (P1).

22. The method according to claim 19, wherein the (T3X) contacting step of the reaction solution with the acid aqueous solution and the (T4) distilling step of the hydrogenated polysilane compound (CX) are carried out.

23. The method according to at claim 1, wherein a concentration of the acid substance in the acid aqueous solution in the (T3) contacting step with the acid aqueous solution is 1% by mass or higher and 60% by mass or lower.

24. The method according to at claim 1, wherein the acid aqueous solution in the (T3) contacting step with the acid aqueous solution comprises at least one selected from hydrochloric acid, sulfuric acid, nitric acid, and phosphoric acid.

25. The method according to claim 1, wherein the (T1) separating step of a solid and a liquid is filtering step.

26. The method according to claim 1, wherein the removing step of the reducing agent (R2) and/or the resulting material of the reducing agent (R2) is at least two or more of the following steps: the (T1) separating step of a solid and a liquid, the (T2) separating step of one liquid and another comprising a reaction solution, a concentrated solution of the reaction solution, or a washing solution of the reaction solution or the concentrated solution of the reaction solution, and the (T3) contacting step with an acid aqueous solution.

27. The method according to claim 26, wherein the removing step of the reducing agent (R2) and/or the resulting material of the reducing agent (R2) comprises:
two of the (T1) separating step of a solid and a liquid, and the (T2) separating step of one liquid and another comprising a reaction solution, a concentrated solution of the reaction solution, or a washing solution of the reaction solution or the concentrated solution of the reaction solution, or
two of the (T2) separating step of one liquid and another comprising a reaction solution, a concentrated solution of the reaction solution, or a washing solution of the reaction solution or the concentrated solution of the reaction solution, and the (T3) contacting step with an acid aqueous solution.

28. The method according to claim 26, further comprising (T4) distilling step of the hydrogenated polysilane compound (CX).

29. The method according to claim 1, wherein the removing step of the reducing agent (R2) and/or the resulting material of the reducing agent (R2) is at least one of the (T3) contacting step of the reducing agent (R2) and/or the resulting material of the reducing agent (R2) with the acid aqueous solution and/or the (T4) distilling step of the hydrogenated polysilane compound (CX).

30. The method according to claim 19, further comprising contacting step of the mixture obtained in the (T3X) contacting step of the reaction solution with the acid aqueous solution or the layer containing the hydrogenated polysilane compound (CX) with water before the distilling step.

31. The method according to claim 1, wherein the polyhalosilane compound (C1) as the halosilane raw material (C0) is produced by contacting step (P3) of a salt of a polyhalosilane compound (C21) with a Lewis acid compound (R3).

32. The method according to claim 31, wherein the Lewis acid compound (R3) is an aluminum halide compound.

33. The method according to claim 32, wherein the contact of the salt of the polyhalosilane compound (C21) with the aluminum halide compound is carried out in the presence of a solvent (S2).

34. The method according to claim 33, wherein the solvent (S2) is one or more solvents selected from the group consisting of a hydrocarbon solvent, an ether solvent, and a halogenated hydrocarbon solvent.

35. The method according to claim 31, wherein the salt of the polyhalosilane compound (C21) as the raw material used in the contacting step (P3) for the production of the polyhalosilane compound (C1) is obtained by contacting step (P31) of a halogenated monosilane compound (C4) with at least one selected from a phosphonium salt and an ammonium salt (R1).

36. The method according to claim 1, wherein the salt of the polyhalosilane compound (C2) as the halosilane raw material (C0) is obtained by contacting step (P4) of the halogenated monosilane compound (C4) with at least one selected from the phosphonium salt and the ammonium salt (R1).

37. The method according to claim 1, wherein the complex of the polyhalosilane compound (C3) as the halosilane raw material (C0) is obtained by contacting step (P5) of the halogenated monosilane compound (C4) with a coordination compound.

38. The method according to claim 37, wherein the coordination compound is at least one selected from the group consisting of the following (i) and (ii).
(i) compound represented by XRₕ (h=3 when X is P, P═O, or N, and R represents a substituted or unsubstituted alkyl or aryl group, either identically or differently; h=2 when X is S, S═O, or O, and R represents a substituted or unsubstituted alkyl or aryl group, either identically or differently, the number of an amino group in XRₕ is 0 or 1.)
(ii) substituted or unsubstituted heterocyclic compound containing N, O, S or P with an unshared electron pair in the ring

39. The method according to at claim 1, wherein the halosilane raw material (C0) is the polyhalosilane compound (C1).

40. The method according to claim 1, wherein the polyhalosilane compound (C1) is a cyclic halosilane compound and the hydrogenated polysilane compound (CX) is a cyclic hydrogenated silane compound.

41. The method according to claim 40, wherein the cyclic hydrogenated silane compound comprises cyclopentasilane or cyclohexasilane.

42. The method according to claim 40, wherein the cyclic hydrogenated silane compound is cyclohexasilane.

43. The method according to claim 1, wherein the polyhalosilane compound (C1) is the cyclic halosilane compound and the hydrogenated polysilane compound (CX) is the cyclic hydrogenated silane compound, and the (T3X) contacting step of the reaction solution of the reducing step (P1) with the acid aqueous solution is carried out as the (T3) contacting step with an acid aqueous solution.

44. The method according to claim 1, wherein
the halosilane raw material (C0) is the cyclic halosilane compound and the hydrogenated polysilane compound (CX) is the cyclic hydrogenated silane compound,
the cyclic halosilane compound is formed by the contacting step (P3) of the salt of the polyhalosilane compound (C21) with the aluminum halide compound in the presence of the solvent (S2), and
the contact of the reducing step (P1) of the cyclic halosilane compound is carried out in the presence of solvent (S1), and
the reducing agent (R2) is the metal hydride (E), and the resulting material of the reducing agent (R2) comprises the aluminum complex, and
the aluminum complex is removed by at least two or more of the following steps: the (T1) filtering step as the separating step of a solid and a liquid, the (T2) separating step of one liquid and another comprising a reaction solution, a concentrated solution of the reaction solution, or a washing solution of the reaction solution or the concentrated solution of the reaction solution, and the (T3) contacting step with an acid aqueous solution.

45. The method according to claim 1, wherein
the halosilane raw material (C0) is the polyhalosilane compound (C1),
the reducing agent (R2) and/or the resulting material of the reducing agent (R2) is a liquid at a temperature of 30° C.,
the contact of the reducing step (P1) is carried out in a batch reactor in the presence of the solvent (S1), and
the removing step of the reducing agent (R2) and/or the resulting material of the reducing agent (R2) is at least one of (T3) contacting step of the reducing agent (R2) and/or the resulting material of the reducing agent (R2) with the acid aqueous solution and the (T4) distilling step of the hydrogenated polysilane compound (CX).
